(19) United States
(12) Patent Application Publication
(10) Pub. No.: US 2007/0013956 A1
(43) Pub. Date: Jan. 18, 2007

(54) Image supply apparatus and recording apparatus, recording system including these appartuses, and communication control method thereof

(76) Inventors: Ruriko Mikami, Tokyo (JP); Takao Aichi, Ohta-ku (JP); Hiromitsu Hirabayashi, Yokohama-shi (JP); Kazuyuki Masumoto, Yokohama-shi (JP); Kentaro Yano, Yokohama-shi (JP); Akitoshi Yamada, Yokohama-shi (JP)

Correspondence Address: FITZPATRICK CELLA HARPER & SCINTO, 30 ROCKEFELLER PLAZA, NEW YORK, NY, 10112, US

(21) Appl. No.: 10/569,061

(22) PCT Filed: Aug. 6, 2004
(86) PCT No.: PCT/JP04/11652

§ 371 Date: Feb. 22, 2006

(30) Foreign Application Priority Data
Aug. 22, 2003 (JP) 2003-298796

(51) Int. Cl. G06K 15/00

(52) U.S. Cl. 358/296; 358/1.14; 358/448

(57) ABSTRACT

In a case where a digital camera cannot understand or recognize a request received from a printer, the camera ignores the received request and discards the received request, and transmits a command that does not include any user instruction or print operation to the printer in place of the correct response to the request. In such case, the printer receives the command as the response to the request, and recognizes that the request transmitted by the printer cannot be accepted by the camera.

### TECHNICAL FIELD

The present invention relates to a recording system having an image supply apparatus such as a digital camera or the like, and a recording apparatus, and a communication control method thereof, and an image supply apparatus, recording apparatus, and communication control method thereof.

### BACKGROUND ART

In recent years, digital cameras (image sensing devices) which can sense an image and can convert the sensed image into digital image data by a simple operation have been popularly used. When an image sensed by such camera is printed and is used as a photograph, it is a common practice to temporarily download the sensed digital image data from a digital camera to a PC (computer), to execute an image process by that PC, and to output the processed image data from the PC to a color printer, thus printing an image.

By contrast, a color print system which allows a digital camera to directly transfer digital image data to a color printer without the intervention of any PC and can print it out (to be referred to as a direct print process hereinafter), a so-called photo-direct (PD) printer which can receive a memory card, which is mounted on a digital camera and stores sensed images, and can print sensed images, and the like have recently been developed (see Japanese Patent Laid-Open No. 2003-061034).

In particular, when image data is directly transferred from a digital camera to a printer upon printing, since digital cameras have different specifications, operation methods, and the like depending on vendors, a photo-direct printer compatible to digital cameras of various vendors is demanded.

In a communication mode of a photo-direct printer compatible to digital cameras of various vendors, a request and response are always paired. Therefore, when a printer sends a request to a digital camera, the digital camera must return an appropriate response to the printer when it receives and interprets the request.

In this case, the digital camera cannot often return a response to the request by reasons that the digital camera is executing some process, and no free buffer area is available, the digital camera cannot interpret the request received from the printer, the digital camera is not ready to interpret the request, and so forth. In this case, since the printer cannot receive any response to the issued request, the printer cannot proceed to the next process, and inconsistency occurs in a communication mode which is effected by a request and response, resulting in communication failures.

### DISCLOSURE OF INVENTION

The present invention has been made in consideration of the above prior art, and a characteristic feature of the present invention is to provide a recording system and communication control method, which can receive and record image data from image supply apparatus of respective vendors since image data transfer and recording instructions are made independently of interfaces.

According to an aspect of the present invention, there are provided an image supply apparatus and recording apparatus, which disable a received request in communication procedures to prevent communication failures if no response can be returned to the request in a recording system in which an image supply apparatus and recording apparatus communicate with each other via a general-purpose interface, and image data is transmitted from the image supply apparatus to the recording apparatus using a predetermined protocol upon recording, a recording system including these apparatuses, and a communication control method thereof.

According to the present invention, there is provided with a recording system in which an image supply apparatus and a recording apparatus communicate with each other via a general-purpose interface, and the image supply apparatus transmits image data to the recording apparatus using a predetermined protocol to record the image data, wherein after a communication procedure is established by applications which are installed in the image supply apparatus and the recording apparatus and use the predetermined protocol, in a case where one of the recording apparatus and the image supply apparatus transmits a request, and a receiving apparatus transmits information other than a response corresponding to the request in response to the request in a case where the receiving apparatus does not process the request, the apparatus that has transmitted the request comprises means for disabling the received information, and the receiving apparatus comprises transmission means for transmitting the information other than the response corresponding to the received request in accordance with status of the receiving apparatus.

Further, according to the present invention, there is provided with a communication control method in a recording system in which an image supply apparatus and a recording apparatus communicate with each other via a general-purpose interface, and the image supply apparatus transmits image data to the recording apparatus using a predetermined protocol to record an image, the method comprising: a step of allowing, in a case where one of the recording apparatus and the image supply apparatus transmits a request, and the receiving apparatus transmits information other than a response corresponding to the request in response to the request in a case where the receiving apparatus does not process the request, the apparatus that has transmitted the request to disable the received information, after a communication procedure is established by applications which are installed in the image supply apparatus and the recording apparatus; and a transmission step of allowing the receiving apparatus to transmit the information other than a response corresponding to the received request in accordance with status of the receiving apparatus.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The accompanying drawings, which are incorporated in and constitute a part of the specification, illustrate embodiments of the invention and, together with the descriptions, serve to explain the principle of the invention.

FIG. 1 depicts a schematic perspective view of a PD printer according to an embodiment of the present invention;

FIG. 2 depicts a schematic view of a control panel of the PD printer according to the embodiment of the present invention;

FIG. 3 is a block diagram showing the arrangement of principal part associated with control of the PD printer according to the embodiment of the present invention;

FIG. 4 is a block diagram showing the arrangement of an ASIC of the PD printer according to the embodiment of the present invention;

FIG. 5 depicts a view for explaining connection of the PD printer and a digital camera according to the embodiment of the present invention;

FIG. 6 depicts a view for explaining the software configurations of the PD printer and digital camera, which incorporate NCDP according to the embodiment of the present invention;

FIG. 7 depicts a view for explaining an overview of NCDP communication procedures according to the embodiment of the present invention;

FIG. 8 depicts a view for explaining commands in NCDP according to the embodiment of the present invention;

FIG. 9 is a chart for explaining print procedures based on “basic procedures” in NCDP according to the embodiment of the present invention;

FIG. 10 is a chart for explaining print procedures based on “recommended procedures” in NCDP according to the embodiment of the present invention;

FIG. 11 is a chart for explaining print procedures upon occurrence of an error in “recommended procedures” in NCDP according to the embodiment of the present invention;

FIG. 12 depicts a view for explaining an example of Capability data transmitted in NCDP according to the embodiment of the present invention;

FIG. 13 is a flow chart for explaining an overview of the NCDP communication procedures according to the embodiment of the present invention;

FIG. 14 depicts a view for explaining an implementation example of a command (NCDPStart) that designates to start the NCDP procedures using a PTP architecture;

FIG. 15 depicts a view for explaining an implementation example of a procedure (ProcedureStart) that receives a shift command to respective procedures from the camera using the PTP architecture;

FIG. 16 depicts a view for explaining an implementation example of a command (NCDPEnd) that designates to end the NCDP procedures using the PTP architecture;

FIG. 17 depicts a view for explaining an implementation example of a command (Capability) that transmits Capability data from the PD printer to the camera in the NCDP procedures using the PTP architecture;

FIG. 18 depicts a view for explaining an implementation example of a procedure of a command (GetImage) that acquires an image file held in the camera from the PD printer in the NCDP procedures using the PTP architecture;

FIG. 19 depicts a view for explaining an implementation example of a procedure of a command (StatusSend) that transmits error status from the PD printer to the camera in the NCDP procedures using the PTP architecture;

FIG. 20 depicts a view for explaining an implementation example of a procedure that transmits an end command (PageEnd) of a print process for one page from the PD printer to the camera in the NCDP procedures using the PTP architecture;

FIG. 21 depicts a view for explaining an implementation example of a procedure that issues an end command (JobEnd) of a print job from the PD printer to the camera in the NCDP procedures using the PTP architecture;

FIG. 22 depicts a view for explaining an implementation example of a procedure that issues a print command (JobStart) from the camera to the PD printer in the NCDP procedures using the PTP architecture;

FIG. 23 depicts a view for explaining an implementation example of a procedure that issues a print abort command (JobAbort) from the camera to the PD printer in the NCDP procedures using the PTP architecture;

FIG. 24 depicts a view for explaining an implementation example of a procedure that issues a print restart command (JobContinue) from the camera to the PD printer in the NCDP procedures using the PTP architecture;

FIG. 25 is a chart for explaining exchange of data based on “recommended procedures” between the DSC and PD printer according to the embodiment of the present invention;

FIG. 26 is a flowchart for explaining a print instruction based on “recommended procedures” in the DSC according to the embodiment of the present invention;

FIG. 27 is a block diagram showing the arrangement of the DSC according to the embodiment of the present invention;

FIG. 28 is a chart for explaining a method of coping with occurrence of collision in NCDP according to the embodiment of the present invention;

FIG. 29 is a flowchart for explaining the process corresponding to the status of the DSC according to the second embodiment of the present invention; and

FIG. 30 is a flowchart for explaining the process corresponding to the presence/absence of a preferential request in the DSC according to the third embodiment of the present invention.

### BEST MODE FOR CARRYING OUT THE INVENTION

Preferred embodiments of the present invention will now be described in detail in accordance with the accompanying drawings.

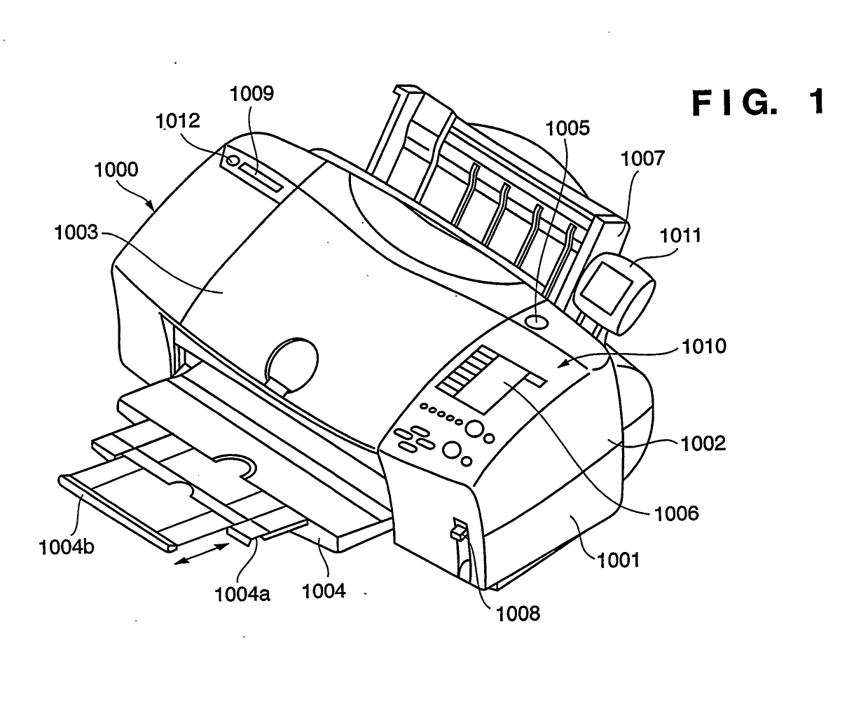

FIG. 1 depicts a schematic perspective view of a photo-direct printer device (to be referred to as a PD printer hereinafter) 1000 according to an embodiment of the present invention. This PD printer 1000 has a function of printing data received from a host computer (PC) as a normal PC printer, and a function of printing image data directly read from a storage medium such as a memory card or the like, and printing image data received from a digital camera, PDA, or the like.

Referring to FIG. 1, a main body which forms a housing of the PD printer 1000 according to this embodiment has a lower case 1001, upper case 1002, access cover 1003, and exhaust tray 1004 as exterior members. The lower case 1001 nearly forms the lower half portion of the PD printer 1000, and the upper case 1002 nearly forms the upper half portion of the main body. By combining these cases, a hollow structure which has a storage space that stores mechanisms to be described later is formed. Openings are respectively formed on the upper and front surfaces of the main body. One end portion of the exhaust tray 1004 is rotatably held by the lower case 1001, and rotation of the tray 1004 opens/closes the opening formed on the front surface of the lower case 1001. Hence, upon executing a print operation, the exhaust tray 1004 is rotated toward the front surface side to open the opening, so that printed sheets (including plain paper, dedicated paper, resin sheet, and the like; to be simply referred to as a sheet hereinafter) can be discharged from the opening. The discharged sheets are stacked on the exhaust tray 1004 in turn. The exhaust tray 1004 stores two auxiliary trays 1004a and 1004b. When these auxiliary trays are pulled out as needed, the loading area of sheets can be enlarged/reduced in three steps.

One end portion of the access cover 1003 is rotatably held by the upper case 1002 to be able to open/close the opening formed on the upper surface of the main body. When the access cover 1003 is opened, a printhead cartridge (not shown), ink tanks (not shown), or the like housed in the main body can be exchanged. Although not shown, when the access cover 1003 is opened/closed, a projection formed on the rear surface of the cover 1003 rotates a cover open/close lever. By detecting the rotation position of that lever using a microswitch or the like, the open/close state of the access cover 1003 is detected.

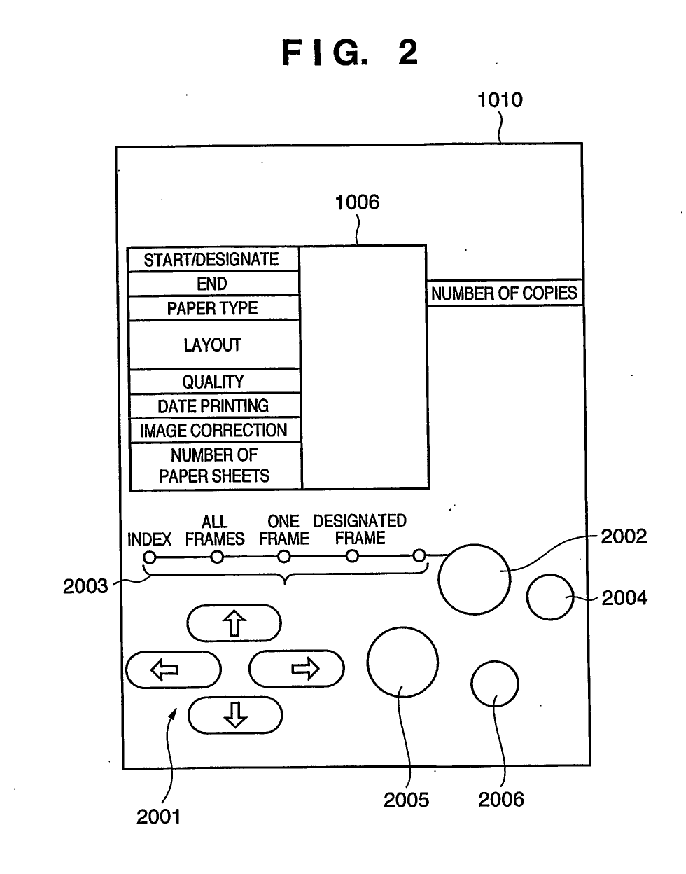

A power key 1005 is arranged on the upper surface of the upper case 1002. A control panel 1010 which comprises a liquid crystal display 1006, various key switches, and the like is provided on the right side of the upper case 1002. The structure of the control panel 1010 will be described in detail later with reference to FIG. 2. Reference numeral 1007 denotes an automatic feeder which automatically feeds a sheet into the device main body. Reference numeral 1008 denotes a paper gap select lever which is used to adjust the gap between the printhead and sheet. Reference numeral 1009 denotes a card slot which receives an adapter that can receive a memory card. Via this adapter, image data stored in the memory card can be directly fetched and printed. As this memory card (PC), for example, a compact flash® memory card, smart media card, memory stick, and the like are available. Reference numeral 1011 denotes a viewer (liquid crystal display unit) which is detachable from the main body of this PD printer 1000, and is used to display an image for one frame, index images, and the like, when the user wants to search images stored in the PC card for an image to be printed. Reference numeral 1012 denotes a USB terminal used to connect a digital camera (to be described later). Also, another USB connector used to connect a personal computer (PC) is provided on the rear surface of this PD printer 1000.

<Overview of Printer Console>

FIG. 2 depicts a schematic view of the control panel 1010 of the PD printer 1000 according to this embodiment.

Referring to FIG. 2, the liquid crystal display unit 1006 displays menu items used to make various setups of data associated with item names printed on the right and left sides of the unit 1006. The items displayed here include, e.g., the first photograph number of a photograph image to be printed of a plurality of photograph image files or designated frame number (start frame designation/print frame designation), the last photograph number of a photograph image to be printed at the end of a print process (end), the number of prints (number of copies), the type of sheet used in a print process (paper type), the setup of the number of photographs to be printed per sheet (layout), designation of print quality (quality), designation as to whether or not to print a photographing date (date printing), designation as to whether or not to print a photograph after correction (image correction), display of the number of sheets required for the print process (number of sheets), and the like. These items are selected or designated using cursor keys 2001. Reference numeral 2002 denotes a mode key. Every time this key is pressed, a print mode (index print, all-frame print, one-frame print, designated-frame print, and the like) can be switched, and a corresponding one of LEDs 2003 is turned on in accordance with the selected print mode. Reference numeral 2004 denotes a maintenance key which is used to do maintenance of the printer (e.g., cleaning of the printhead, and the like). Reference numeral 2005 denotes a print start key which is pressed when the start of a print process is instructed or when the maintenance setup is settled. Reference numeral 2006 denotes a print cancel key which is pressed when a print process or maintenance is canceled.

<Overview of Printer Electric Specification>

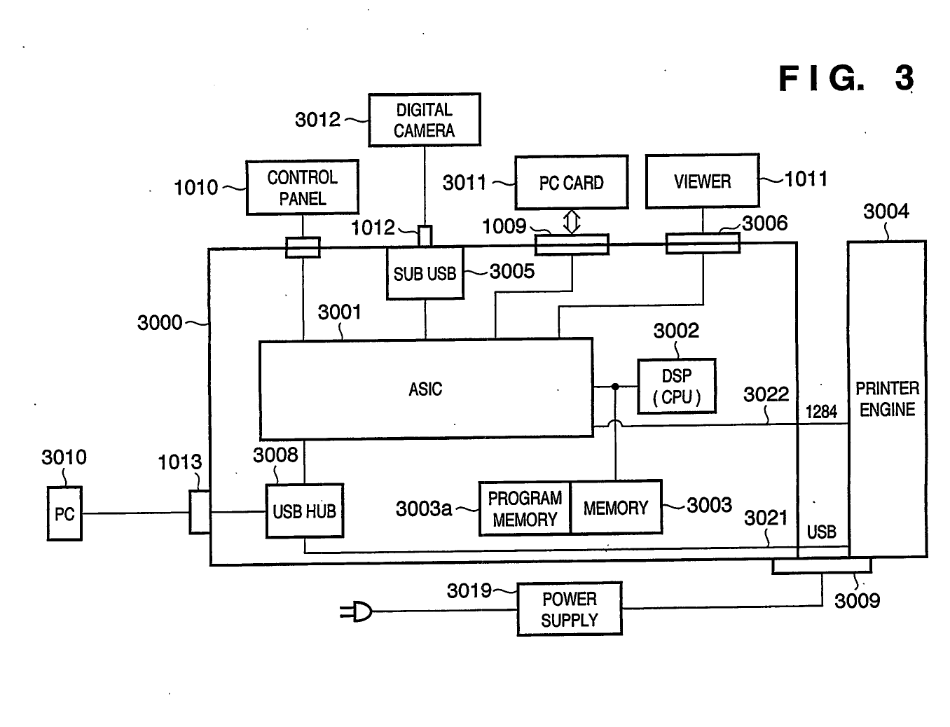

The arrangement of principal part associated with the control of the PD printer 1000 according to this embodiment will be described below with reference to FIG. 3. Note that the same reference numerals in FIG. 3 denote parts common to those in the above drawings, and a description thereof will be omitted.

Referring to FIG. 3, reference numeral 3000 denotes a controller (control board). Reference numeral 3001 denotes an ASIC (application specific LSI). Reference numeral 3002 denotes a DSP (digital signal processor), which includes a CPU and executes various control processes to be described later, and image processes such as conversion from a luminance signal (RGB) into a density signal (CMYK), scaling, gamma conversion, error diffusion, and the like. Reference numeral 3003 denotes a memory, which has a program memory 3003a for storing a control program to be executed by the CPU of the DSP 3002, a RAM area for storing a running program, and a memory area that serves as a work area for storing image data and the like. Reference numeral 3004 denotes a printer engine. In this embodiment, the printer is equipped with a printer engine of an ink-jet printer which prints a color image using a plurality of color inks. Reference numeral 3005 denotes a USB connector as a port for connecting a digital camera (DSC) 3012. Reference numeral 3006 denotes a connector for connecting the viewer 1011. Reference numeral 3008 denotes a USB hub (USB HUB). When the PD printer 1000 executes a print process based on image data from a PC 3010, the USB hub 3008 allows data received from the PC 3010 to pass through it, and outputs the data to the printer engine 3004 via a USB 3021. In this way, the PC 3010 connected to the printer can execute a print process by directly exchanging data, signals, and the like with the printer engine 3004 (the printer serves as a normal PC printer). Reference numeral 3009 denotes a power supply connector, which inputs a DC voltage which is converted from commercial AC power by a power supply 3019. The PC 3010 is a general personal computer. Reference numeral 3011 denotes a memory card (PC card) mentioned above; and 3012, a digital camera (DSC: Digital Still Camera).

Note that signals are exchanged between this controller 3000 and printer engine 3004 via the aforementioned USB 3021 or an IEEE 1284 bus 3022.

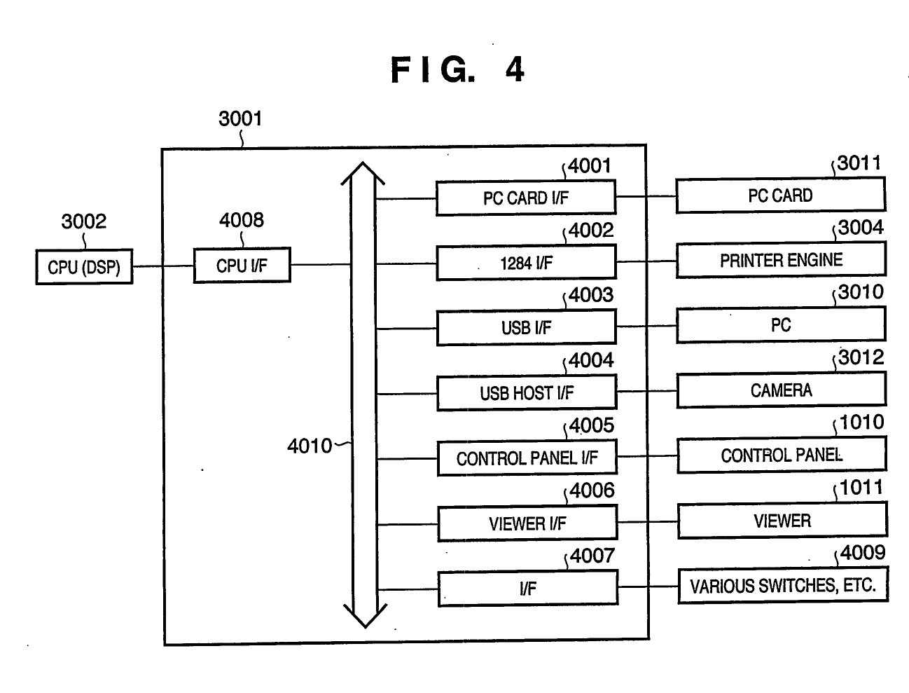

FIG. 4 is a block diagram showing the arrangement of the ASIC 3001. In FIG. 4 as well, the same reference numerals denote parts common to those in the above drawings, and a description thereof will be omitted.

Reference numeral 4001 denotes a PC card interface, which reads image data stored in the inserted PC card 3011, or writes data in the PC card 3011. Reference numeral 4002 denotes an IEEE 1284 interface, which exchanges data with the printer engine 3004. This IEEE 1284 interface 4002 is a bus used when image data stored in the digital camera 3012 or PC card 3011 is to be printed. Reference numeral 4003 denotes a USB interface, which exchanges data with the PC 3010. Reference numeral 4004 denotes a USB host interface, which exchanges data with the digital camera 3012. Reference numeral 4005 denotes a control panel interface, which receives various operation signals from the control panel 1010, and outputs display data to the display unit 1006. Reference numeral 4006 denotes a viewer interface, which controls display of image data on the viewer 1011. Reference numeral 4007 denotes an interface, which controls interfaces with various switches, LEDs 4009, and the like. Reference numeral 4008 denotes a CPU interface, which controls data exchange with the DSP 3002. Reference numeral 4010 denotes an internal bus (ASIC bus), which interconnects these interfaces.

An overview of the operation based on the above arrangement will be explained below.

<Normal PC Printer Mode>

This mode is a print mode for printing an image on the basis of print data sent from the PC 3010.

In this mode, when data from the PC 3010 is input via the USB connector 1013 (FIG. 3), it is directly sent to the printer engine 3004 via the USB hub 3008 and USB 3021, and a print process is executed based on the data from the PC 3010.

<Direct Print Mode from PC Card>

When the PC card 3011 is attached to or detached from the card slot 1009, an interrupt is generated, and the DSP 3002 can detect based on this interrupt whether or not the PC card 3011 is attached or detached (removed). When the PC card 3011 is attached, compressed image data (e.g., compressed by JPEG) stored in that PC card 3011 is read and stored in the memory 3003. If the user issues a print instruction of the stored image data using the control panel 1010, the compressed image data is decompressed, and is stored in the memory 3003. The image data is converted into print data that can be printed by the printer engine 3004 by executing conversion from RGB signals into YMCK signals, gamma correction, error diffusion, and the like, and the print data is output to the printer engine 3004 via the IEEE 1284 interface 4002, thus printing an image.

<Overview of Camera/Printer Connection>

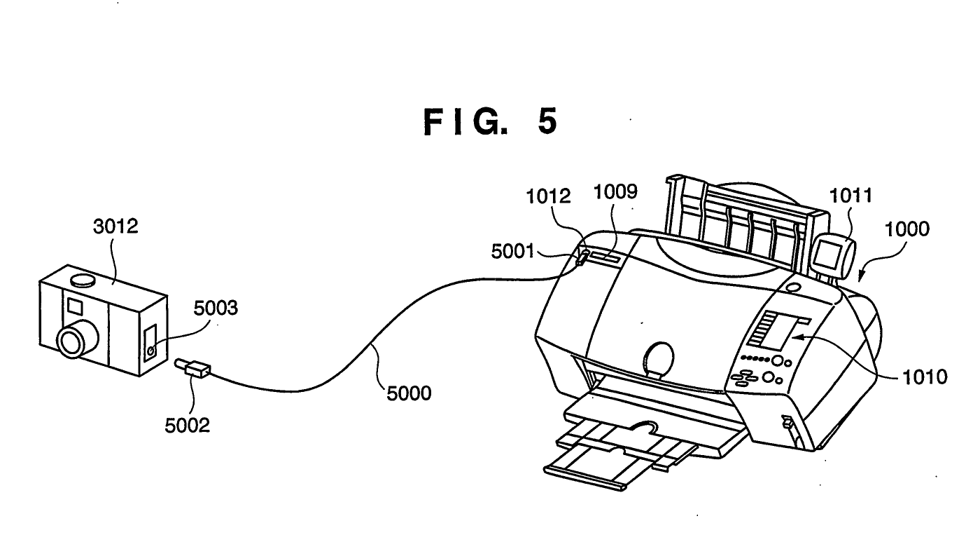

FIG. 5 depicts a view for explaining connection of the PD printer 1000 and digital camera 3012 according to the first embodiment. The same reference numerals in FIG. 5 denote parts common to those in the above drawings, and a description thereof will be omitted.

Referring to FIG. 5, a cable 5000 comprises a connector 5001 which is connected to the connector 1012 of the PD printer 1000, and a connector 5002 which is connected to a connector 5003 of the digital camera 3012. The digital camera 3012 can output image data saved in its internal memory via the connector 5003. Note that the digital camera 3012 can adopt various arrangements, e.g., an arrangement that comprises an internal memory as storage means, an arrangement that comprises a slot for receiving a detachable memory, and so forth. When the PD printer 1000 and digital camera 3012 are connected via the cable 5000 shown in FIG. 5, image data output from the digital camera 3012 can be directly printed by the PD printer 1000.

An object of this embodiment is to provide a PD printer which can connect digital cameras of a plurality of vendors and can print data. Protocols required upon executing a print process by connecting the PD printer 1000 according to this embodiment and a digital camera will be described in detail hereinafter.

This embodiment proposes NCDP (New Camera Direct Print) which makes communication control between the PD printer and digital camera using a general-purpose file and general-purpose format, and is independent from interfaces.

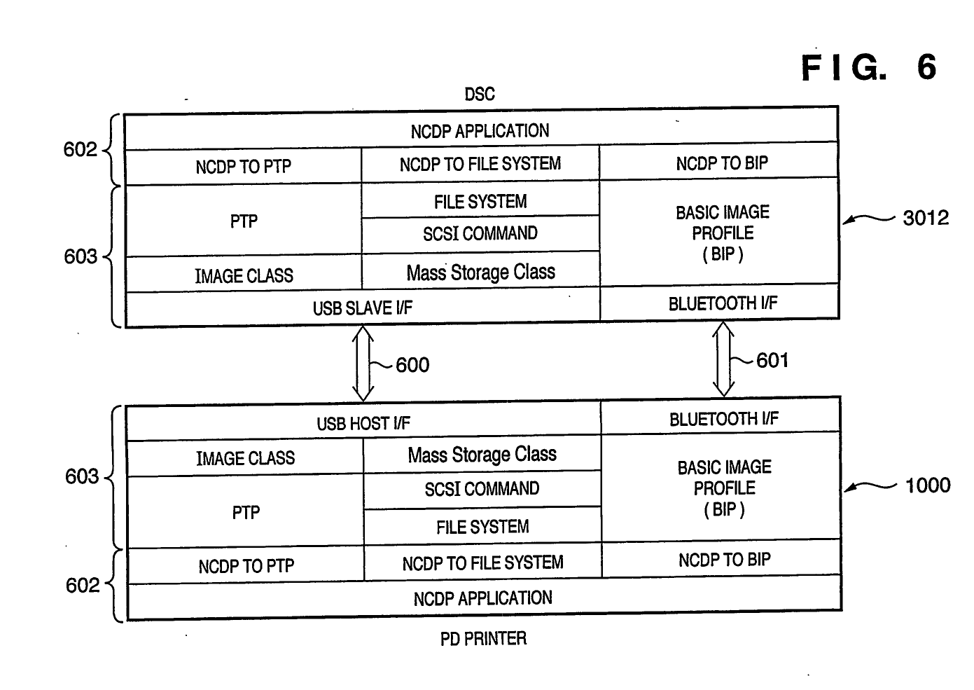

FIG. 6 shows an example of the configuration of this NCDP.

Referring to FIG. 6, reference numeral 600 denotes a USB interface; and numeral 601 denotes a Bluetooth interface. Reference numeral 602 denotes an application layer which is built in upon forming an NCDP system. Reference numeral 603 denotes a layer that implements existing protocols and interfaces. In FIG. 6, PTP (Picture Transfer Protocol), SCSI, BIP (Basic Image Profile) of Bluetooth, and the like are installed. NCDP according to this embodiment is premised on that an architecture such as a protocol layer and the like is adopted, and NCDP is supported as an application on the architecture. In this case, the PD printer 1000 and digital camera 3012 are respectively defined as USB host and USB slave; they have the same NCDP configurations, as shown in FIG. 6.

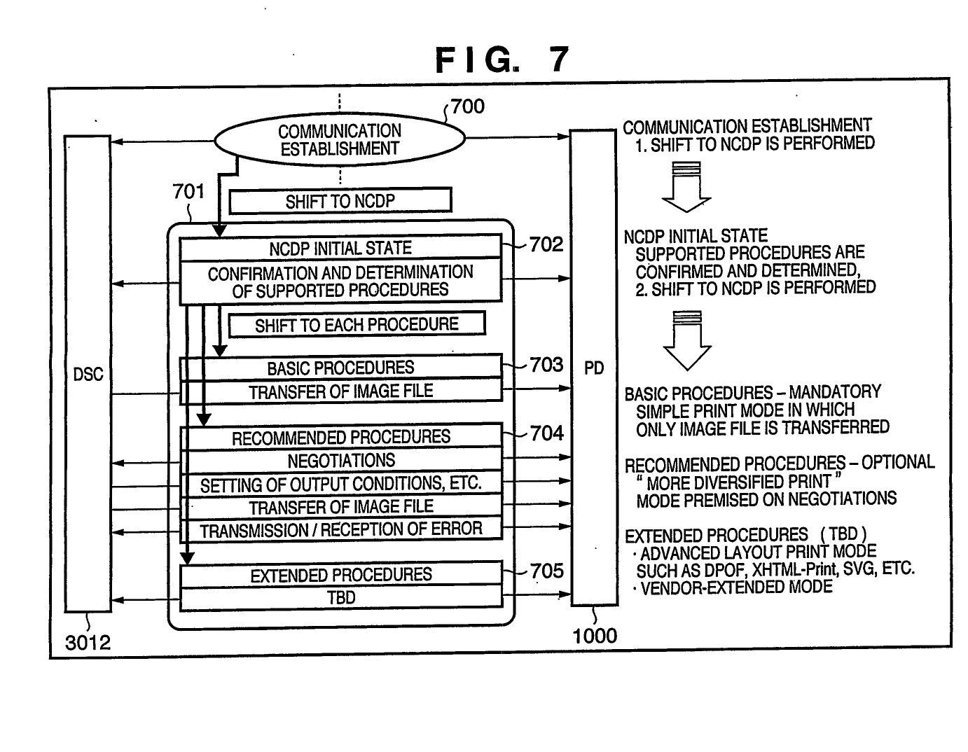

FIG. 7 depicts a view for explaining the flow of communication procedures between the PD printer 1000 and DSC 3012 on the basis of NCDP according to this embodiment.

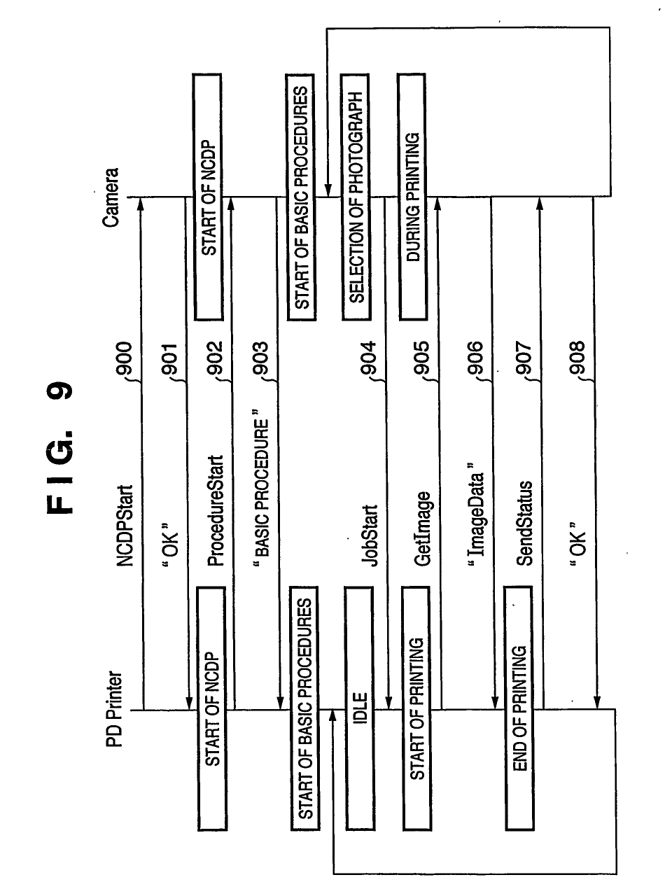

In this case, when it is detected that the PD printer 1000 and DSC 3012 have been connected via the USB cable 5000, as shown in FIG. 5, these devices can communicate with each other. As a result, applications installed in these devices are executed to start shift to NCDP procedure 701. Reference numeral 702 denotes an NCDP initial state. In this state, whether or not each other's models can implement NCDP is determined. If NCDP can be implemented, the flow shifts to NCDP procedure 701. If the DSC 3012 does not support NCDP, no NCDP communication control is executed. If the DSC 3012 issues a transfer/print instruction of image data based on “basic procedures” after shift to the NCDP, as indicated by 703, the flow shifts to a simple print mode in which an image file is transferred from the DSC 3012 to the PD printer 1000, and is printed. On the other hand, if the DSC 3012 issues a transfer/print instruction of image data based on “recommended procedures”, as indicated by 704, the flow shifts to a print mode corresponding to diversified functions, in which the DSC 3012 and PD printer 1000 make various negotiations to determine the print condition and the like, an image file is transferred from the DSC 3012 to the PD printer 1000, and the transferred image file is printed. Furthermore, reference numeral 705 denotes “extended procedures”. If the DSC 3012 issues this “extended procedures” instruction, a mode that executes a print process using an advanced layout function such as DPOF, XHTML-print, SVG, or the like and specifications unique to each vendor is set. Note that the detailed specifications based on the “extended procedures” are specified in the specifications of each individual DSC vendor, and a description thereof will be omitted. Note that the image print processes based on these “basic procedures” and “recommended procedures” will be described later with reference to FIGS. 9 to 11.

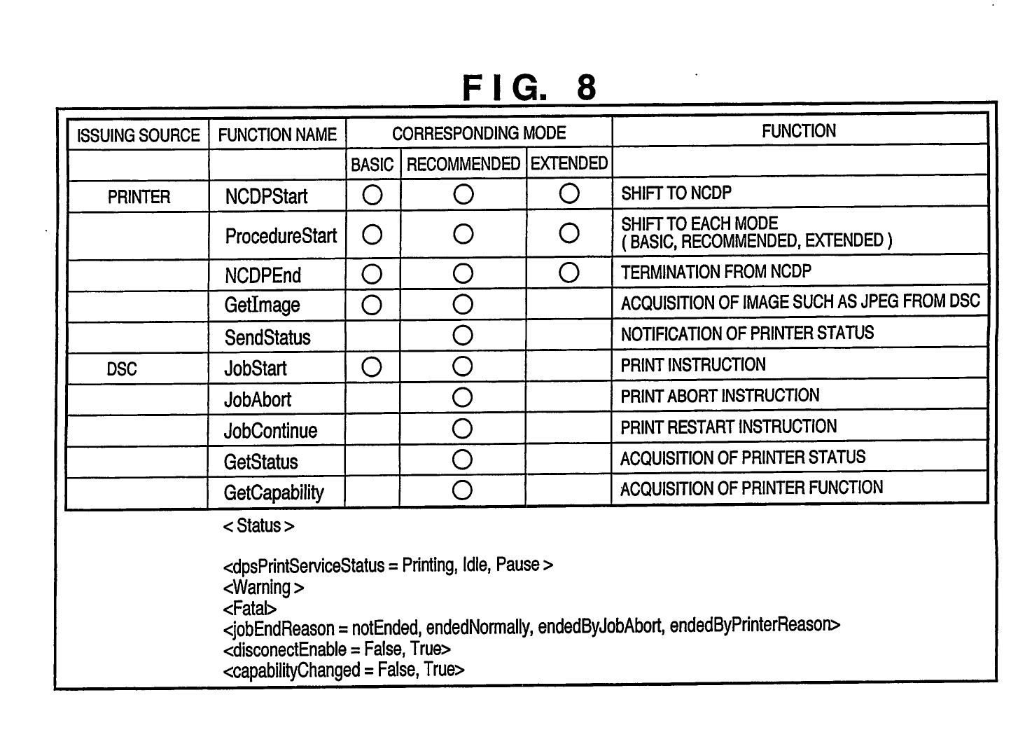

FIG. 8 depicts a view for explaining commands which are defined to print in NCDP according to this embodiment.

Referring to FIG. 8, “corresponding mode” corresponds to the above “basic procedures”, “recommended procedures”, and “extended procedures” designated by the DSC 3012. In “recommended procedures”, all commands can be used. However, since “basic procedures” correspond to a simple print mode, only a shift to NCDP command and an NCDP end command, shift commands to the modes of “basic procedures”, “recommended procedures”, and “extended procedures”, an acquisition command of image data from the camera 3012, and a print command from the camera 3012 can be used. In “extended procedures”, only a shift to NCDP command and an NCDP end command, and shift commands to the modes of “basic procedures”, “recommended procedures”, and “extended procedures” are allowed to be used in FIG. 8. However, as described above, other commands may be used in accordance with the specifications of respective vendors.

The image print processes based on the above “basic procedures” and “extended procedures” will be explained below.

FIG. 9 is a chart for explaining the NCDP communication procedures when an image print process is executed based on “basic procedures”. The “basic procedures” correspond to a simple print mode in which one image file is transferred from the DSC 3012 to the PD printer 1000 and is printed. Compatible image formats include an RGB image of the VGA size (640×480 pixels) and a JPEG image of the VGA size (640×480 pixels). The image file size is about 1 Mbytes or less. The DSC 3012 transmits an image file in an image format supported by the PD printer 1000. In this case, no error handling is executed.

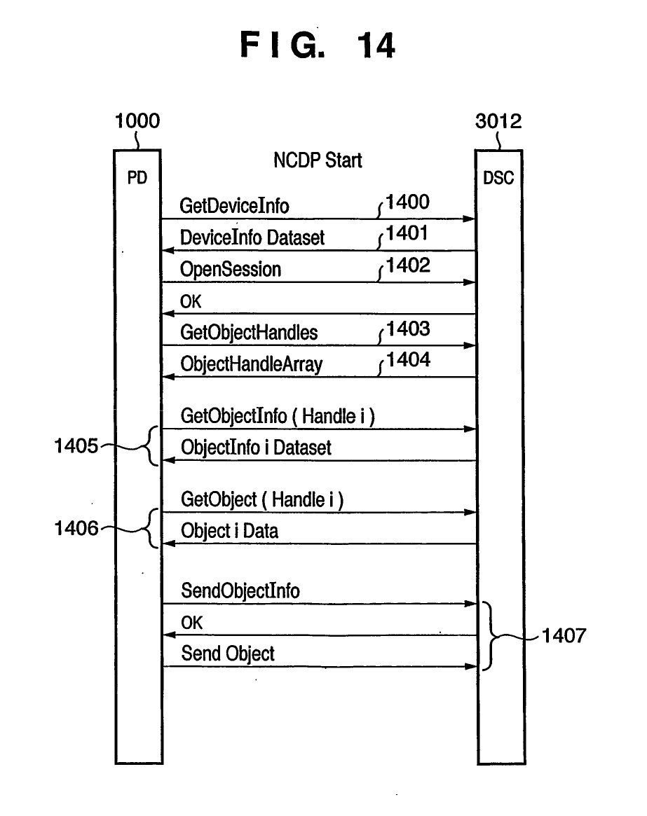

The PD printer 1000 sends a command (NCDPStart) indicating shift to the NCDP to the DSC 3012 (900). If the DSC 3012 supports the NCDP, it replies “OK” (901). Note that a practical example of the NCDP confirmation procedures using PTP will be explained in detail later with reference to FIG. 14.

If the PD printer 1000 and DSC 3012 confirm each other that they support the NCDP, the PD printer 1000 transmits to the DSC 3012 an instruction (ProcedureStart) for shifting to the NCDP mode (902). In response to this command, when the DSC 3012 transmits “basic procedures” as a simple print mode (903), the control shifts to a print mode based on “basic procedures”. In this case, when an image to be printed is selected and its print instruction is issued upon operation on the DSC 3012, a command (JobStart) indicating the start of a print job is sent from the DSC 3012 to the PD printer 1000 (904). In response to the command, the PD printer 1000 is set in the simple print mode, and sends a command (GetImage) to the DSC 3012 to request it to send a JPEG image (905). Then, the DSC 3012 sends a JPEG image to the PD printer 1000 (906), and a print process in the PD printer 1000 starts. Upon completion of the print process of the designated image, the PD printer 1000 sends a command (SendStatus) indicating the end of the print job to the DSC 3012 (907). When the DSC 3012 returns an acknowledgement (OK) in response to this command (908), the print process based on this “basic procedures” ends. Note that it is determined based on Capability data of both the DSC and PD printer whether or not exchange is made in the “basic procedures”.

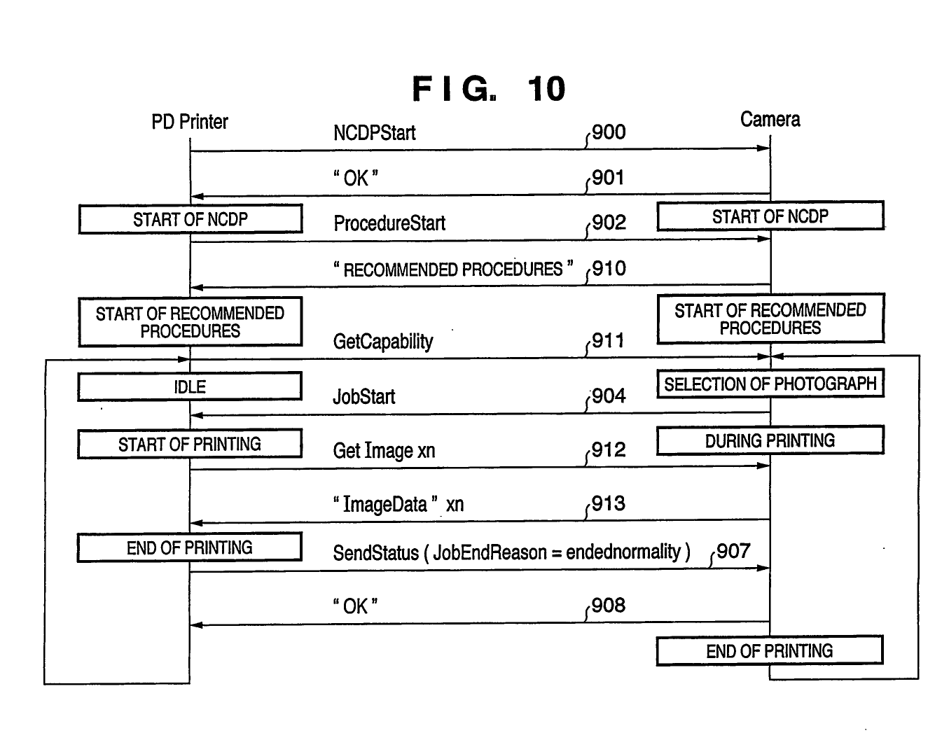

FIG. 10 is a chart for explaining the NCDP communication procedures when an image print process is executed based on “recommended procedures”. The same reference numerals in FIG. 10 denote procedures common to those in FIG. 9, and a description thereof will be omitted. In the “recommended procedures”, a “more diversified print” mode premised on negotiation between the PD printer 1000 and DSC 3012 can be set, and photo print and layout print processes of a plurality of images can be made. Also, error handling can be executed.

In FIG. 10, after the PD printer 1000 and DSC 3012 confirm each other as in FIG. 9 that they support NCDP, the DSC 3012 designates “recommended procedures” (910) in this case. After that, procedures based on the “recommended procedures” are executed. In response to a Capability request from the DSC 3012 to the PD printer 1000, the PD printer 1000 notifies the DSC 3012 of its all functions and those including a paper setup and the like as Capability information (911). This Capability information is transmitted to the DSC 3012 in a script format (text).

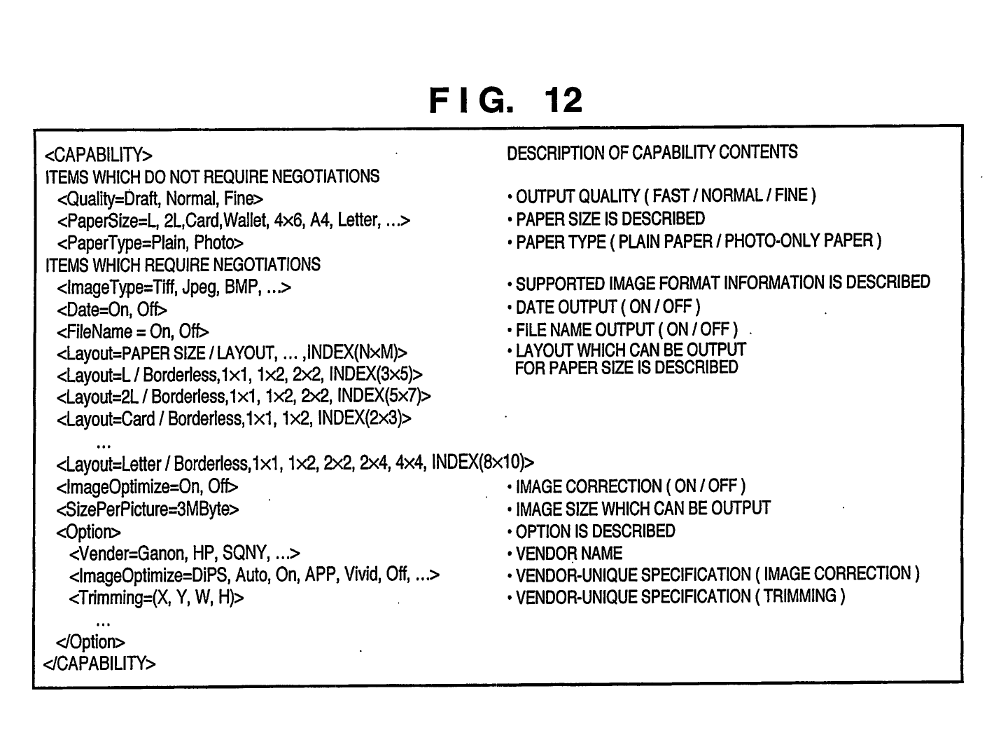

FIG. 12 shows an example of this Capability information.

As shown in FIG. 12, this Capability information includes information of the printable paper types and sizes, print quality, image data format, date print (ON/OFF), file name print (ON/OFF), layout, and image correction (ON/OFF), and also information of the availability of functions corresponding to the specification of each camera vendor and the like as options.

Script notation of the Capability information facilitates export to architectures of other communication protocols and standardization of exchange of such function information. Note that this script notation may comply with XML.

The user of the DSC 3012 that has received such Capability information determines which of the functions of the PD printer 1000 is to be used in a print process, selects an image to be printed, and selects and determines the print conditions of that image from the functions of the PD printer 1000. After the user determines the image to be printed, its print condition, and the like, and designates the start of a print process, a print instruction (JobStart) is sent to the PD printer 1000. The PD printer 1000 then issues a command (GetImage xn) that requests the image data (912), and the DSC 3012 transmits the corresponding image data in an image format (Tiff, JPEG, RGB, or the like) that can be received by the PD printer 1000 (913), in response to that command. The reason why a plurality of image data can be transmitted for an image print process per paper sheet is that when, for example, a 2×2 layout print mode or the like is designated, four image data must be transmitted per sheet. Upon completion of the print process of the designated image, the PD printer 1000 transmits status information (SendStatus) indicating the end of the print job to the DSC 3012 (907). In this case, “endednormaly” indicating normal end is transmitted. When the DSC 3012 returns an acknowledgement (OK) in response to this information (908), the control starts the select and print processes of the next image based on this “recommended procedures” again.

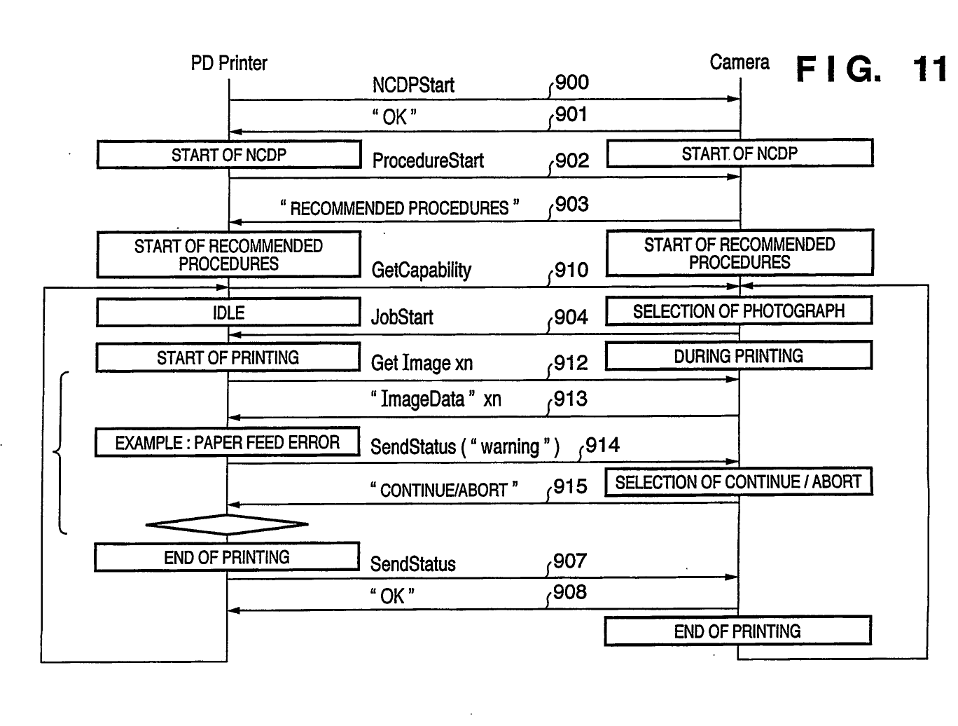

FIG. 11 is a chart for explaining the communication procedures when an error has occurred in the PD printer 1000 in the NCDP communication procedures upon executing an image print process based on the above “recommended procedures”. The same reference numerals in FIG. 11 denote procedures common to those in FIG. 10, and a description thereof will be omitted.

FIG. 11 exemplifies a case wherein a paper feed error has occurred in the PD printer 1000 during the print process based on “recommended procedures”. In this case, the PD printer 1000 sends status information (SendStatus(“Warning”)) indicating the paper feed error to the DSC 3012 (914). In response to this information, a command indicating if the print process is to be continued (JobContinue) or aborted (JobAbort) is transmitted to the PD printer 1000 on the basis of the decision by the user of the DSC 3012 (915). If “abort” is designated, the PD printer 1000 aborts the print process, and transmits a print job end message (JobEnd). On the other hand, if “continue” is designated, the apparatus continues the print process after the paper feed error is recovered.

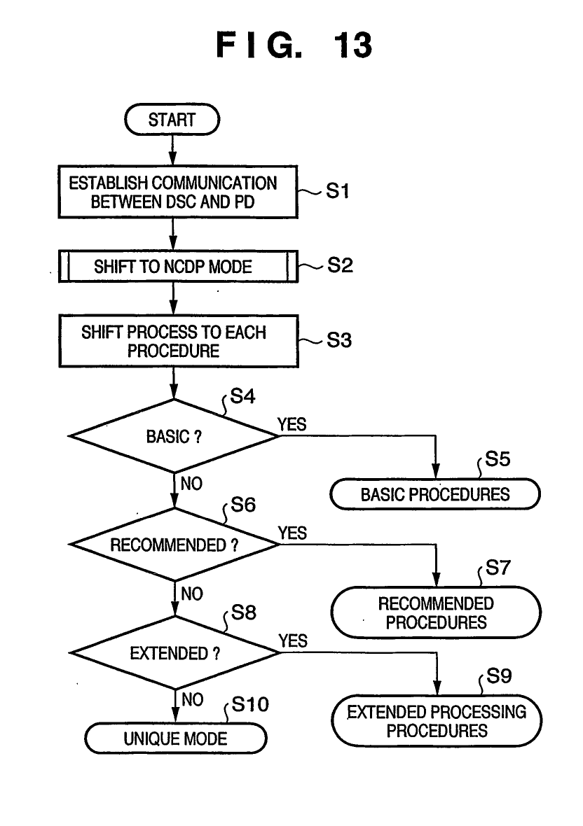

The aforementioned processing procedures will be explained below with reference to the flowchart of FIG. 13.

FIG. 13 is a flowchart for explaining the processing procedures shown in FIG. 7.

In step S1, a communication is established between the digital camera (DSC) 3012 and PD printer 1000 (700). It is determined in step S2 whether these devices support the NCDP. If these devices support the NCDP, the NCDP mode starts. The flow then advances to step S3 to receive a procedure designation from the DSC 3012, and to start the designated procedures. If “basic procedures” are designated, the flow advances from step S4 to step S5 to execute a print process based on “basic procedures”. On the other hand, if “recommended procedures” are designated, the flow advances from step S6 to step S7 to execute a print process based on “recommended procedures”. Furthermore, if “extended procedures” are designated, the flow advances from step S8 to step S9 to execute a print process based on “extended procedures” corresponding to each vendor. If other procedures are designated, the flow advances to step S10 to execute a print process in a mode unique to the PD printer 1000 and DSC 3012.

An example (PTP wrapper) wherein various NCDP commands (FIG. 8) mentioned above are implemented using general-purpose PTP will be described below. In this embodiment, the NCDP using PTP will be exemplified. However, the present invention is not limited to such specific example. For example, a direct print service API may be implemented on another interface or another class (Class).

[NCDPStart]

FIG. 14 depicts a view for explaining an implementation example of a command (NCDPStart) that designates to start the NCDP procedures using the PTP architecture.

After the PD printer 1000 and DSC 3012 are physically connected, the PD printer 1000 transmits GetDeviceInfo to the DSC 3012 (1400) to request it to send information associated with objects held by the DSC. In response to this request, the DSC 3012 transmits information about objects held by itself to the PD printer 1000 using DeviceInfo Dataset. By OpenSession (1402), a start request of procedures that assign the DSC 3012 as a resource, assign handles to data objects as needed, and make a special initialization process is issued. Upon reception of an acknowledgement (OK) from the DSC 3012, PTP communications start. The PD printer 1000 requests the DSC 3012 to send all script handles (Storage ID: FFFFFF, Object Type: Script) (1403). In response to this request, the DSC 3012 returns a list of all handles held by it (1404). Information of the i-th object handle is acquired from the PD printer 1000 (1405, 1406). If this object includes a keyword (e.g., “Marco”) indicating identification of the DSC 3012, the PD printer 1000 instructs to send object information (SendObjectInfo) (1407). Upon reception of an acknowledgement (OK) in response to this instruction, the PD printer 1000 transmits object information to the DSC 3012 by SendObject. Note that this object includes, e.g., “Polo” as a response keyword corresponding to the aforementioned keyword.

In this manner, the PD printer 1000 and DSC 3012 can recognize each other as connected partners. After that, the control can shift to the NCDP procedures (701 in FIG. 7). Transport layers that can exchange files can reliably exchange keywords. That is, keywords can be exchanged without adding any unique commands to the NCDP of this embodiment. Note that the keywords are not limited to the aforementioned example, and the PD printer and DSC may use the same keyword. In order to shorten the time required for negotiations using the keywords, each keyword may be set at the head of a script handle. As a result, the time required to confirm partner devices can be shortened.

[ProcedureStart]

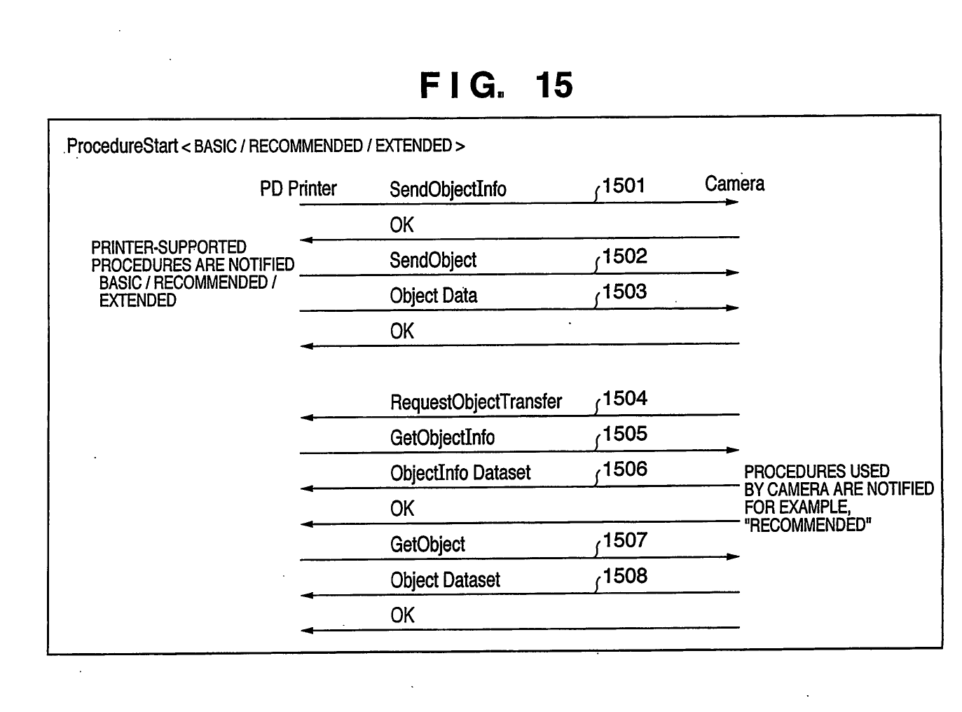

FIG. 15 depicts a view for explaining an implementation example of an instruction (ProcedureStart) used to start a given mode upon reception of an instruction that designates a shift procedure to that mode from the DSC 3012 using the PTP architecture.

In order to notify the DSC 3012 of procedures “basic procedures”, “recommended procedures”, and “extended procedures” supported by the PD printer 1000, the PD printer 1000 notifies the DSC 3012 of the presence of object information to be sent to it using SendObjectInfo (1501). Upon reception of an acknowledgement (OK) from the DSC 3012 in response to this command, the PD printer sends a message indicating that it is ready to transmit an object to the DSC 3012 using SendObject (1502), and then transmits information associated with the procedures supported by the PD printer 1000 using ObjectData (1503). The DSC 3012 notifies the PD printer 1000 that it wants to launch a GetObject operation (shift to a push mode) (1504). If the PD printer 1000 sends a message indicating that it is ready to receive information associated with object information (GetObjectInfo) (1505), that information is returned using ObjectInfo Dataset (1506). If object information itself is requested by designating that object information (1507), the DSC 3012 informs the PD printer 1000 of procedures (“basic”, “recommended”, “extended”, and the like) that the DSC 3012 uses by Object Dataset (1508).

In this manner, the DSC 3012 can designate an image print mode of the PD printer 1000.

[NCDPEnd]

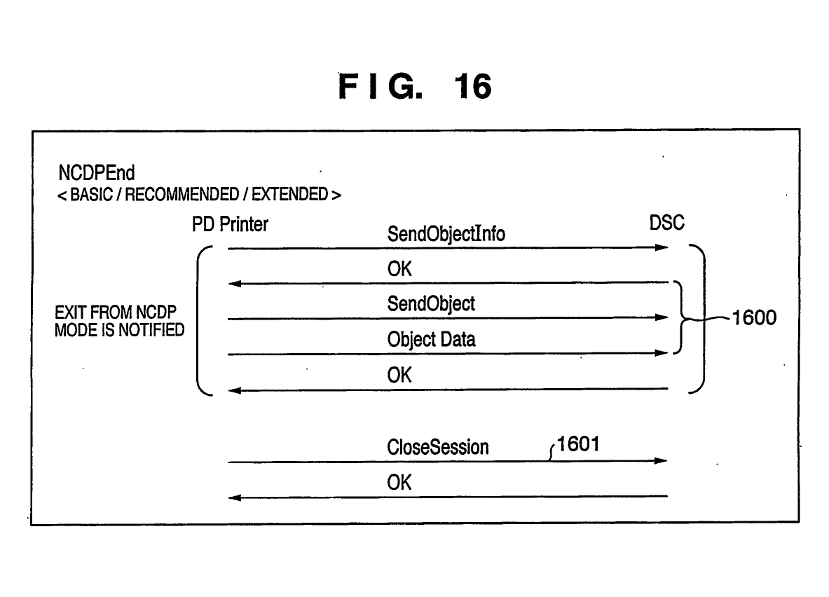

FIG. 16 depicts a view for explaining an implementation example of an instruction (NCDPEnd) used to end the NCDP communication control procedures according to this embodiment using the PTP architecture.

In this procedure, the PD printer 1000 informs the DSC 3012 of the presence of object information to be sent to it (1600), and notifies the DSC 3012 that it leaves the NCDP mode using ObjectData. Upon reception of an acknowledgement (OK), CloseSession is transmitted (1601) to end this communication. In this way, the NCDP communication procedures end.

[getCapability]

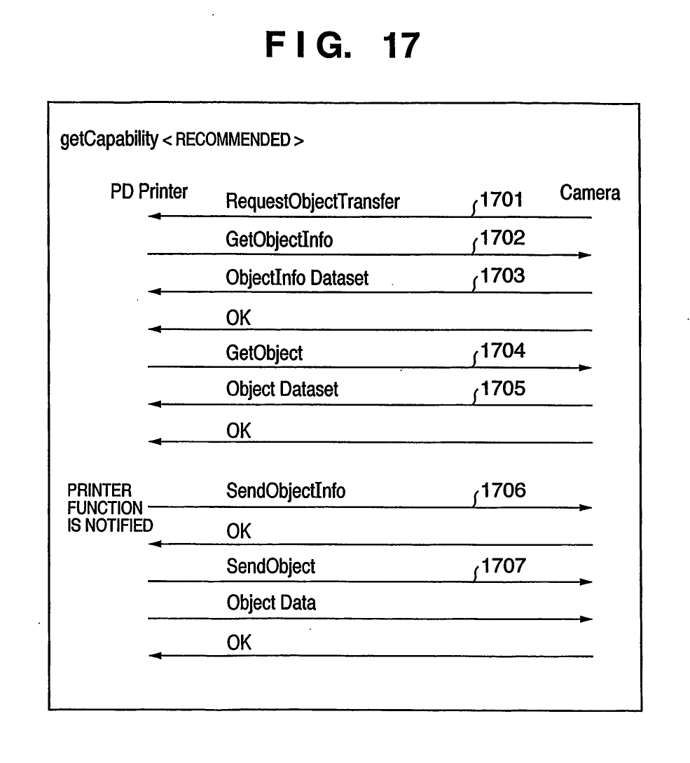

FIG. 17 depicts a view for explaining an implementation example of communication procedures in a Capability instruction used to notify the DSC 3012 of the functions of the PD printer 1000 in NCDP of this embodiment using the PTP architecture.

In this procedure, the DSC 3012 informs the PD printer 1000 of the presence of an object to be sent to it using (RequestObjectTransfer) (1701). If the printer 1000 requests information of that object (1702), the DSC 3012 notifies the printer 1000 of a data set of the object to be transferred (1703). If the printer 1000 issues an acquisition command (GetObject) of the object to the DSC 3012 (1704), the object is transmitted from the DSC 3012 to the printer 1000 in response to that command. As a result of transmission of this object, it is determined that the DSC 3012 requests the printer 1000 to send Capability data (1705).

The printer 1000 then transmits information associated with the requested object held by it to the DSC 3012. Capability information indicating the functions of the printer 1000 is transmitted from the PD printer 1000 to the DSC 3012 in a script format using SendObject and ObjectData (1707). In this manner, the PD printer 1000 and DSC 3012 can exchange their function information.

[GetImage]

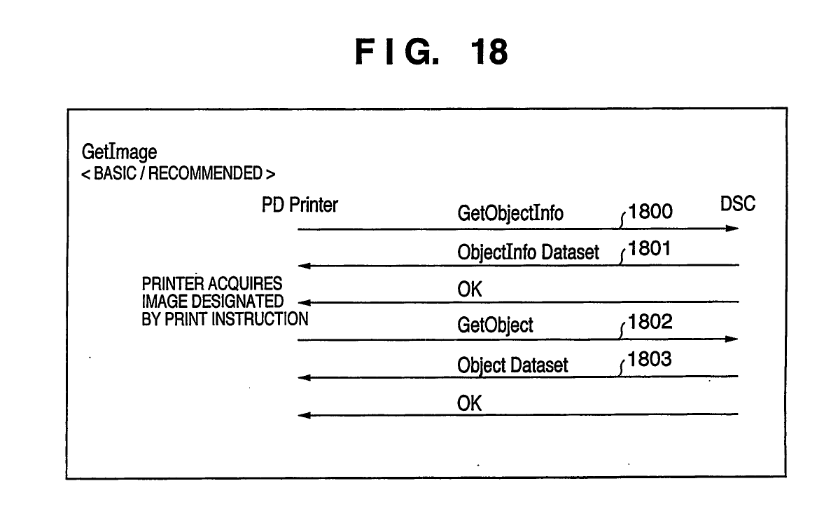

FIG. 18 depicts a view for explaining an implementation example of communication procedures executed when the PD printer 1000 acquires image data (JPEG image) held by the DSC 3012 (GetImage) in NCDP of this embodiment using the PTP architecture.

Upon sending a request of information associated with an object held by the DSC 3012 (1800), the DSC 3012 sends information (Object Dataset) associated with that object to the PD printer 1000 (1801). If an acquisition request (GetObject) is issued by designating that object (1802), the DSC 3012 transmits the requested image file (Object Dataset) to the PD printer 1000 (1803). In this way, the PD printer 1000 can acquire a desired image file from the DSC 3012.

[SendStatus]

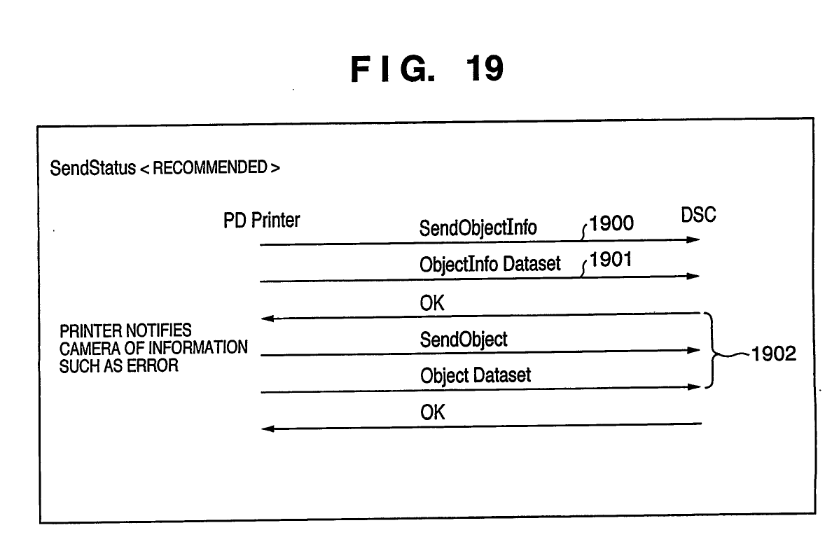

FIG. 19 depicts a view for explaining an implementation example of communication procedures executed when the PD printer 1000 notifies the DSC 3012 of error status or the like (SendStatus) in the NCDP of this embodiment using the PTP architecture.

The PD printer 1000 notifies the DSC 3012 of the presence of object information to be sent to it using SendObjectInfo (1900). Then, the PD printer 1000 transmits an information set (Object Dataset) associated with the object information to the DSC 3012 (1901). In response to an acknowledgement (OK) from the DSC 3012, status information of errors or the like in the PD printer 1000 is transmitted using SendObject and Object Dataset.

[PageEnd]

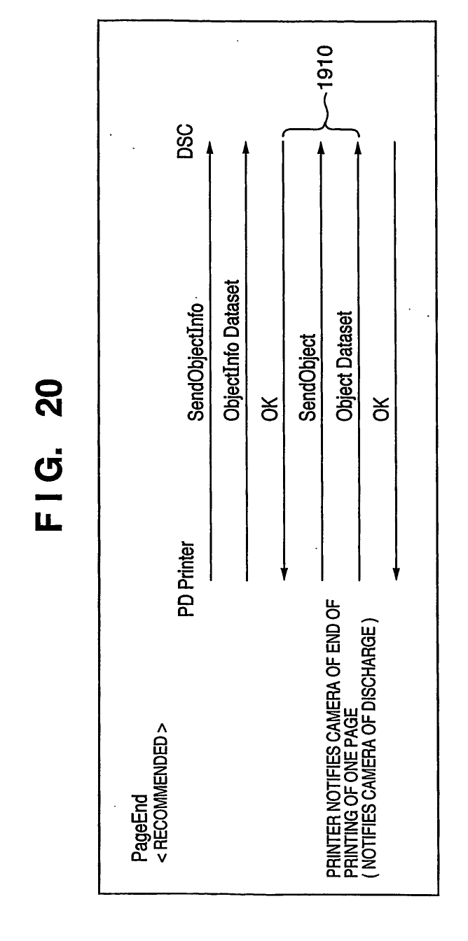

FIG. 20 depicts a view for explaining an implementation example of communication procedures executed when the PD printer 1000 notifies the DSC 3012 of the end of a print process for one page (PageEnd) in the NCDP of this embodiment using the PTP architecture.

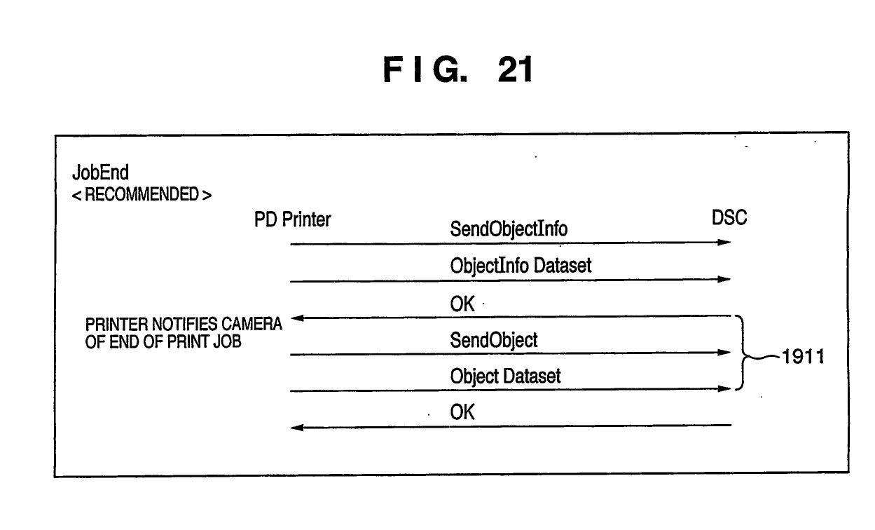

FIG. 21 depicts a view for explaining an implementation example of communication procedures executed when the PD printer 1000 notifies the DSC 3012 of the end of a print job (JobEnd) in the NCDP of this embodiment using the PTP architecture.

In FIGS. 20 and 21, after execution of procedures 1900 and 1901 in FIG. 19, the PD printer 1000 notifies the DSC 3012 of the end of the print process for one page (1910 in FIG. 20), and the PD printer 1000 notifies the DSC 3012 of the end of the print job (1911 in FIG. 21).

[JobStart]

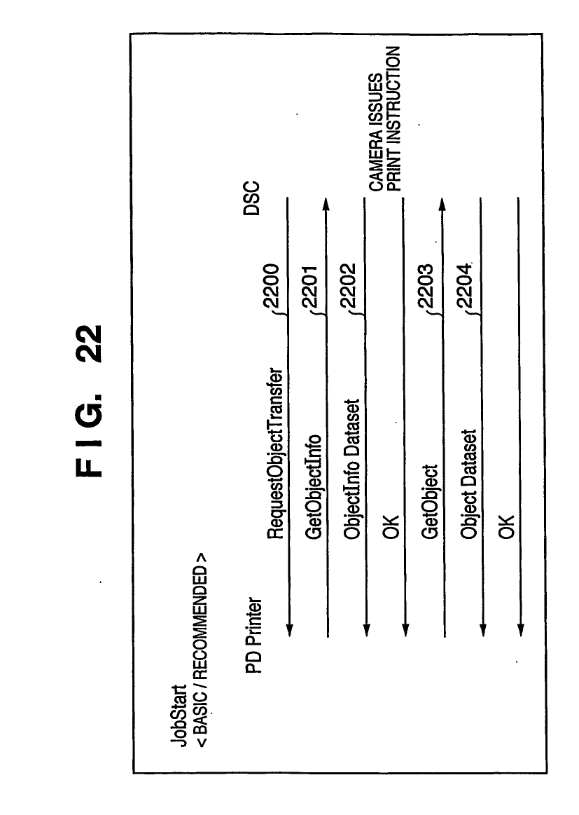

FIG. 22 depicts a view for explaining an implementation example of communication procedures executed when the DSC 3012 notifies the PD printer 1000 of the start of a print job (JobStart) in the NCDP of this embodiment using the PTP architecture.

The DSC 3012 sends RequestObjectTransfer to the PD printer 1000 (2200) so as to urge the PD printer 1000 to issue a GetObject command. As a result, if the PD printer 1000 issues GetObjectInfo (2201), the DSC 3012 transmits information associated with object information to be transmitted. In response to this information, if the PD printer 1000 requests object information (GetObject: 2203), Object Dataset is transmitted to issue a print instruction from the DSC 3012 to the PD printer 1000 (2204).

[JobAbort]

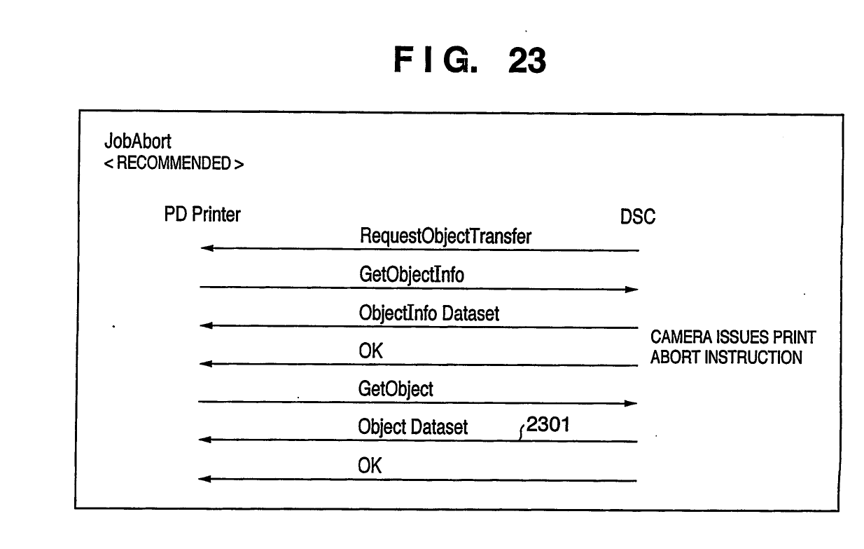

FIG. 23 depicts a view for explaining an implementation example of communication procedures executed when the DSC 3012 issues a print abort instruction to the PD printer 1000 (JobAbort) in the NCDP of this embodiment using the PTP architecture.

[JobContinue]

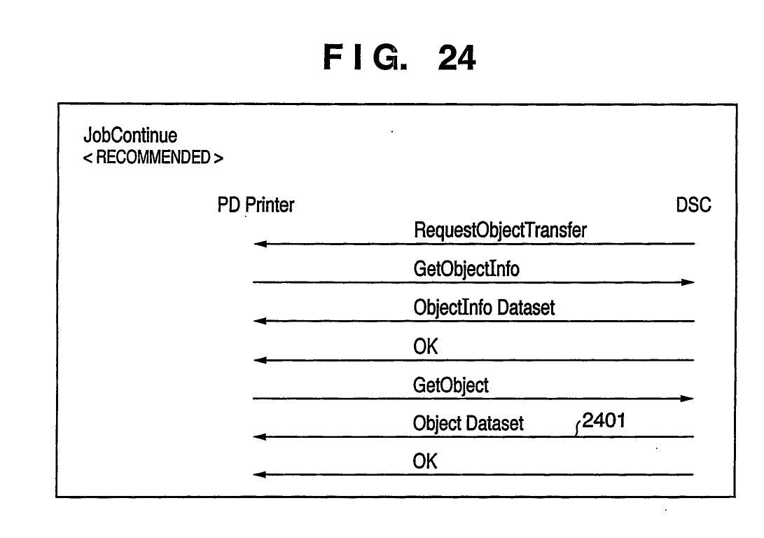

FIG. 24 depicts a view for explaining an implementation example of communication procedures executed when the DSC 3012 issues a print restart instruction to the PD printer 1000 (JobContinue) in the NCDP of this embodiment using the PTP architecture.

In FIGS. 23 and 24, after procedures 2200 to 2203 in FIG. 22 are executed, the DSC 3012 issues a print abort instruction to the PD printer 1000 (2301 in FIG. 23), and sends a print restart instruction to the PD printer 1000 (2401 in FIG. 24).

[Capability]

The communication procedures between the PD printer 1000 and DSC 3012 and the processes in the PD printer 1000 and DSC 3012 as characteristic features according to this embodiment will be described below.

In this embodiment, since the DSC 3012 connected to the PD printer 1000 is based on the assumption that unspecified digital cameras manufactured by respective vendors are connected, even when the PD printer 1000 transmits information of its all functions to the DSC as Capability information, that DSC may not often recognize all or some contents of the Capability information. In such case, a print job file which describes print conditions that the PD printer 1000 did not intend is sent from the DSC. If the PD printer 1000 cannot execute a print process under the print conditions designated by that print job file, it notifies the DSC that the received print job cannot be processed.

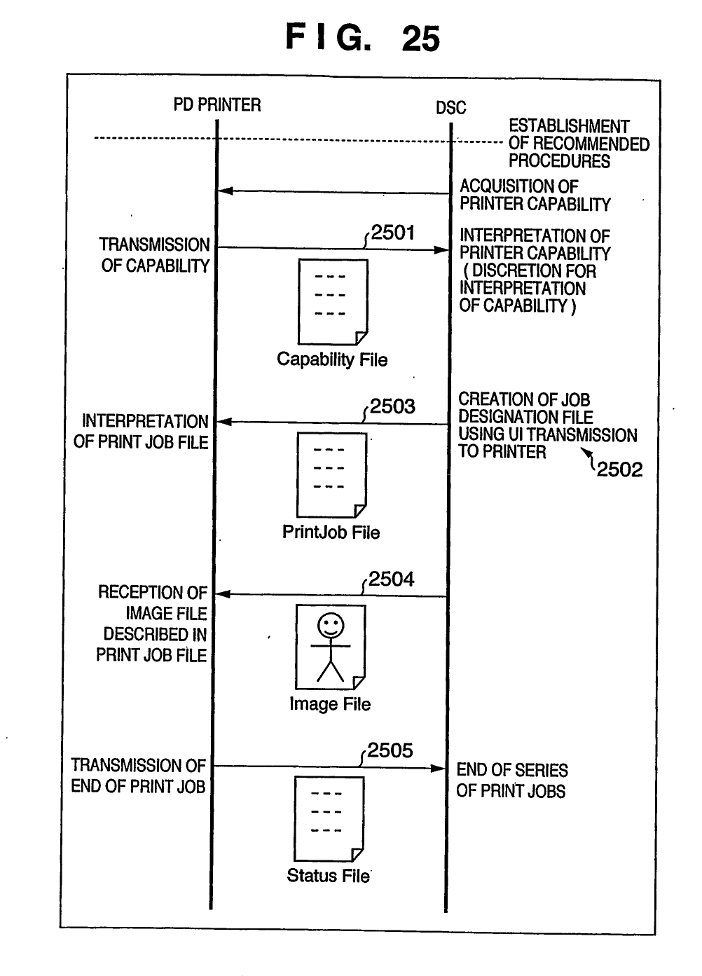

FIG. 25 is a chart for explaining the exchange procedures of Capability information in “recommended procedures” shown in FIG. 11.

Referring to FIG. 25, the PD printer 1000 transmits Capability information in the script notation to the DSC 3012 (2501), as described above. The DSC 3012 interprets this Capability information, and ignores items which cannot be understood if any. The user of the DSC 3012 designates an image file to be printed and print conditions (paper type, paper size, image quality, and the like) using the UI of the DSC 3012 (2502). In this way, a print job file that designates a print job is generated. The DSC 3012 sends the print job file that designates the print job to the PD printer 1000 (2503). Upon reception of the job file, the PD printer 1000 interprets the contents described in the print job file, and prints an image file received in 2504 under the print conditions designated by the print job file. Upon completion of the print process, the PD printer 1000 notifies the DSC 3012 of the end of the print job (2505).

When the paper size set in the PD printer 1000 is “L size”, but “A4 size” is designated as the Capability paper size in the print job file received from the DSC 3012, the PD printer 1000 notifies the DSC that the print job cannot be processed.

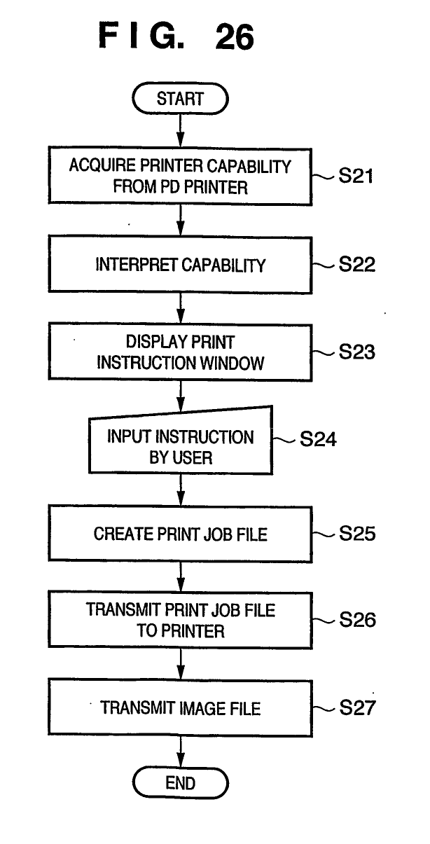

FIG. 26 is a flowchart for explaining the process in the DSC 3012 in the aforementioned processing sequence based on “recommended procedures”.

If Capability information is received from the PD printer 1000 in step S21, the flow advances to step S22 to interpret the Capability information. If there are items that cannot be understood, they are ignored. The flow advances to step S23 to display a print instruction window (UI) on the display unit of the camera 3012, and the user inputs a print instruction using the UI window in step S24. After the print instruction is input, the flow advances to step S25 to generate a print job file that describes an image file to be printed, various print conditions, and the like, which are set using the UI. In step S26, the print job file is transmitted to the PD printer 1000. In step S27, the image file described in the print job file is transmitted to the PD printer 1000.

<Overview of Digital Camera>

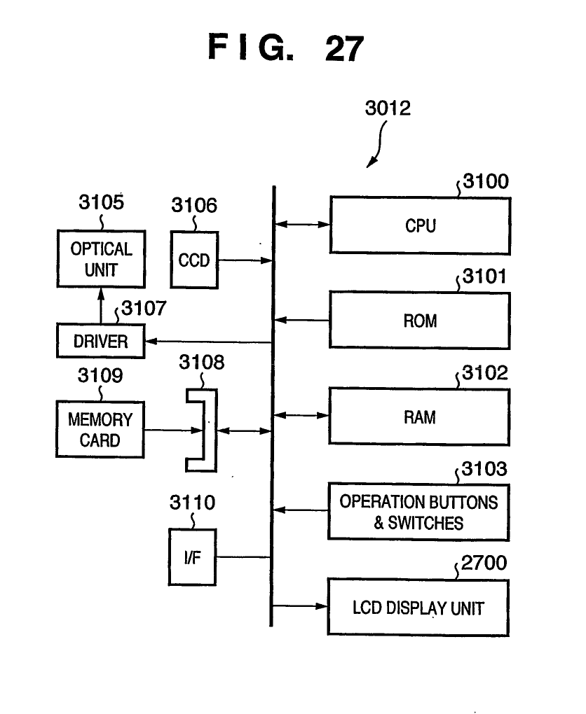

FIG. 27 is a block diagram showing the arrangement of the DSC (digital camera) 3012 according to this embodiment.

Referring to FIG. 27, reference numeral 3100 denotes a CPU which controls the overall DSC 3012; and numeral 3101 denotes a ROM that stores the processing sequence by the CPU 3100. Reference numeral 3102 denotes a RAM which is used as a work area of the CPU 3100; and numeral 3103 denotes a switch group which is used to make various operations, and includes a shutter, mode switch, select switch, cursor keys, and the like. Reference numeral 2700 denotes a liquid crystal display unit which is used to display a video picture that is captured currently, and images photographed and stored in the memory card, and to display a menu upon making various setups. Reference numeral 3105 denotes an optical unit which mainly comprises a lens and its drive system. Reference numeral 3106 denotes a CCD element; and numeral 3107 denotes a driver for controlling to drive the optical unit 3105 under the control of the CPU 3100. Reference numeral 3108 denotes a connector used to connect a storage medium 3109 (compact flash® memory card, smart media, or the like); and numeral 3110 denotes a USB interface (slave side of the USB) used to connect a PC or the PD printer in this embodiment.

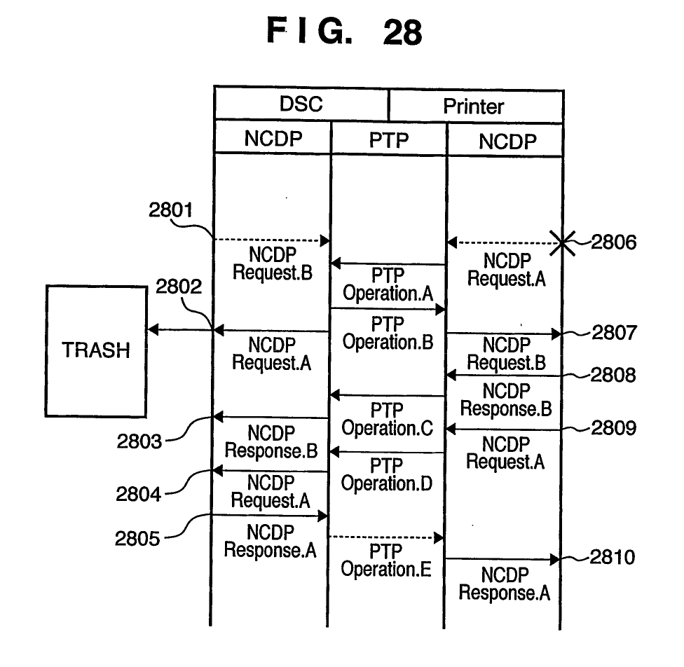

FIG. 28 is a chart for explaining the processing procedures that exemplify occurrence of collision of a request and recovery from the collision between the DSC 3012 and PD printer 1000 in the NCDP according to the first embodiment of the present invention. This collision occurs when a request (request A) transmitted from the DSC 3012 to the PD printer 1000 collides against a request (request B) transmitted from the PD printer 1000 to the DSC 3012. FIG. 28 depicts a situation that, for example, when the DSC 3012 transmits the request A to the PD printer 1000 (2801), the DSC 3012 normally receives a response A to the request A from the PD printer 1000, but a request B has been issued from the PD printer 1000 at substantially the same timing as the request A (2806) from the DSC 3012 and the DSC 3012 receives it.

The process in the DSC 3012 will be explained first.

The DSC 3012 transmits the request B to the PD printer 1000 (2801). The DSC 3012 waits for reception of the response B to the request B from the PD printer 1000. The DSC 3012 checks if a command received from the PD printer 1000 is the response B to the request B (2802). If NO is determined (the DSC 3012 receives the request A issued by the PD printer 1000 at nearly the same timing as 2801 in FIG. 28), the DSC 3012 discards the received request. The DSC 3012 waits for reception of the response B (2803), and determines whether a command received from the PD printer 1000 is the response B. If the DSC 3012 receives the response B from the PD printer 1000 (2803), it confirms that the request B transmitted in 2801 has been received by the PD printer 1000.

If the DSC 3012 receives the request A re-issued by the PD printer 1000 (2804), it transmits the response A to the request A to the PD printer 1000 (2805).

As described above, if collision has occurred between the DSC 3012 and the PD printer 1000, the DSC 3012 waits for reception of a response (response B) to the request B transmitted to the PD printer 1000. If the DSC 3012 receives a command or response other than the response (response B) during waiting, it discards the received command or response to avoid problems due to the collision.

The process in the PD printer 1000 in the NCDP will be described below.

The PD printer 1000 transmits the request A to the DSC 3012 at nearly the same timing as 2801 above (2806). The PD printer 1000 then waits for reception of the response A to the request A (2807). However, the PD printer 1000 receives the request B issued by the DSC 3012 in 2801 (2807). As a result, the PD printer 1000 transmits the response B to the request B received in 2807 (2808). The PD printer 1000 re-transmits the request A to the DSC 3012 as in 2806 above (2809). The PD printer 1000 determines whether a command received from the DSC 3012 is the response A to the request A (2810). If the PD printer 1000 determines that the received command is the response A, the printer 1000 executes a process of the received command.

As described above, the PD printer 1000 always returns a response to a request received from the DSC 3012. If collision is likely to occur, i.e., no response (response A in this case) to the transmitted request is received, the previously issued request (request A) is re-issued to the DSC 3012. In this way, even when collision has occurred, the DSC 3012 and PD printer 1000 can be avoided from not advancing to the next processing step.

### Second Embodiment

In the second embodiment, a communication process between the PD printer 1000 which transmits a request to the DSC 3012, and the DSC 3012 which can not interpret the request received from the PD printer 1000 will be explained. Note that the arrangements of the DSC 3012 and PD printer 1000 in the second embodiment are the same as those of the DSC 3012 and PD printer 1000 in the first embodiment, and a description thereof will be omitted.

As described above, communication means according to the embodiment corresponds to a communication specification in which a request and response are always paired. For this reason, both the DSC 3012 and PD printer 1000 must return a response to a request if they receive the request. In the second embodiment, the response includes a response indicating “affirmative”, a response indicating that “a request can never be processed”, and a response indicating that “a request cannot be processed now”.

More specifically, when each of the DSC 3012 and PD printer 1000 receives a request, it interprets the contents of the request. As a result of interpretation, if the contents of the request cannot be understood or a request to unsupported function information is included, a response indicating that the “the request can never be processed” is returned. This response notifies the DSC 3012 or PD printer 1000 which has received the response that the request as the cause of the response is never processed in the communication if it is requested at any given timing.

When the contents of the request can be understood but cannot be processed at the present timing for some reason, a response indicating that the “request cannot be processed now” is returned. The response notifies the DSC 3012 or PD printer 1000 which has received the response that the request as the cause of the response cannot be processed now but may be able to be processed if the request is re-issued.

When the contents of the request can be understood, and the request can be processed, a response indicating “affirmative” is returned. In this case, the DSC 3012 or PD printer 1000 that has received the response processes the request, and notifies the partner device that the next request can be transmitted.

Under the above assumption, when the DSC 3012 receives a request from the PD printer 1000, it must interpret the request and return an appropriate response. For example, assume that the DSC 3012 cannot interpret the received request, and tentatively returns a response indicating that the “request cannot be processed now” without normally interpreting the request. In this case, upon reception of the response, the PD printer 1000 re-issues the same request after an elapse of a predetermined period of time. As a result, the DSC 3012 receives the request again, and interprets it. At this time, if it is determined that the request includes a request to a function which is not supported by the DSC 3012, the DSC 3012 returns a response indicating that the “request can never be processed”. In this case, the PD printer 1000 determines that the request will be processed sooner or later if it repetitively issues the request, since it has received the response indicating that the “request cannot be processed now” in response to the first request. However, if the PD printer receives the response indicating that the “request can never be processed” in response to the re-sent request, the response is inconsistent with the first response, and the PD printer is likely to be confused.

For this reason, upon reception of a request from the PD printer 1000, if a situation in which that request cannot be interpreted has occurred, the DSC 3012 cannot tentatively return an appropriate response, and cannot return any irresponsible response since the printer may be confused. As a result, the DSC 3012 is stuck, thus failing the communication with the PD printer 1000. Hence, this embodiment prevents occurrence of such problem.

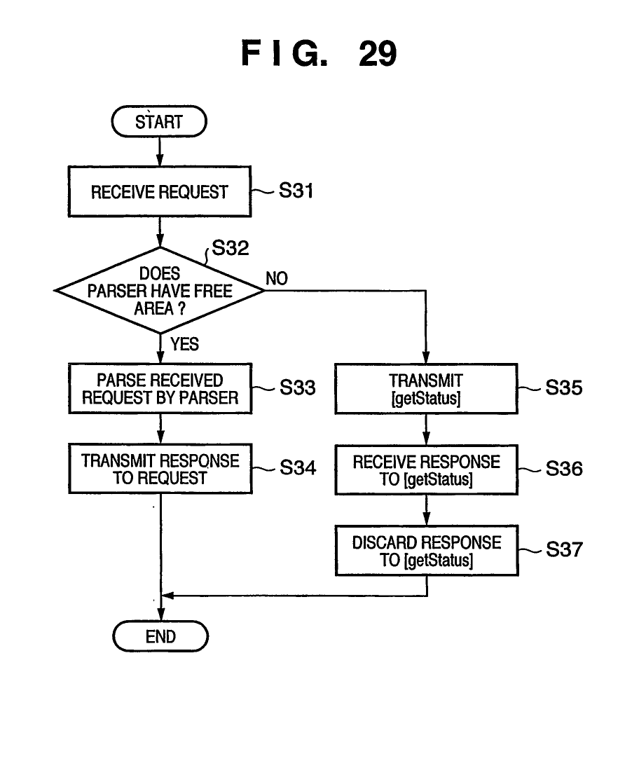

FIG. 29 is a flowchart for explaining the process in the DSC 3012 according to the second embodiment of the present invention. A program that implements this process is stored in the ROM 3101.

Upon reception of a request from the PD printer 1000 in step S31, the flow advances to step S32 to determine whether the DSC 3012 is ready to interpret the received request. If the DSC 3012 is ready to interpret the received request, the flow advances to step S33, and the DSC 3012 interprets the request. The flow then advances to step S34 to return an appropriate response.

On the other hand, if it is determined in step S32 that the DSC 3012 is not ready to interpret the request, the flow advances to step S35 to discard the request since the DSC 3012 cannot return any response to the request received in step S31. More specifically, the DSC 3012 transmits “GetStatus” to the PD printer 1000 in response to the request received in step S31 in step S35 to request the status of the PD printer 1000. The flow advances to step S36 to receive a response to the “GetStatus” from the PD printer 1000. In this case, the PD printer 1000 recognizes that collision has occurred since it does not receive any response to the issued request, and recognizes that the previously issued request has been discarded by the DSC 3012. The flow advances to step S37 to discard the response received in step S36. This is because “GetStatus” transmitted from the DSC 3012 in step S35 is a dummy command used to notify the PD printer 1000 that the request received in step S31 has been discarded, and the contents of its response need not be interpreted.

Note that the command which is sent from the DSC 3012 to the PD printer 1000 in step S35 to notify that the received request has been discarded is not particularly limited as long as the command does not include any user's instruction or a response to the command from the PD printer does not include any operation instruction to the DSC 3012. Therefore, a command that can be transmitted at an arbitrary timing irrespective of a status request is preferably used. For example, “GetCapability” or the like may be used.

As described above, when a request is received, and a response to the request cannot be returned, an insignificant request is transmitted to the PD printer in response to the received request in place of a corresponding response, thus intentionally causing collision. In this way, the DSC 3012 can disable the request received from the PD printer 1000. As a result, even when the DSC 3012 is not ready to interpret a request, the communication with the PD printer can be prevented from failing. When the DSC 3012 receives a request from the PD printer 1000 again if it is ready to interpret the request, the DSC 3012 can reliably return a response to the request.

### Third Embodiment

The second embodiment has explained the process of a request executed by the DSC 3012 while it is not ready to interpret the received request. In the third embodiment, the process of the DSC 3012 which has no free area in a memory will be explained. Note that the arrangements of the DSC 3012 and PD printer 1000 in the second embodiment are the same as those of the DSC 3012 and PD printer 1000 in the first embodiment, and a description thereof will be omitted.

More specifically, the DSC 3012 has no free area on its memory (RAM 3102) in a case where the DSC 3012 uses the memory to generate a request to be transmitted to the PD printer 1000, in a case where a request which is just about to be transmitted to the PD printer 1000 occupies the memory, and so forth. In recent years, a size reduction and price reduction of the DSC 3012 do not allow the DSC 3012 to have a large-capacity memory.

Under the aforementioned assumption, the DSC 3012 cannot return any response to a request received from the PD printer 1000 since a memory area used to render the contents of the request received from the PD printer 1000 and a memory area required to transmit the response are insufficient. As a result, since the printer cannot receive any response, a communication failure occurs, and the print process is disturbed due to the communication failure, resulting in user's confusion.

In such case, as in the second embodiment, it is determined in step S32 whether the memory (RAM 3102) has a free area in place of determining if the DSC is ready to interpret the received request. If the memory has a free area, the flow advances to step S33; otherwise, the flow advances to step S35, thus solving the aforementioned problem as in the second embodiment.

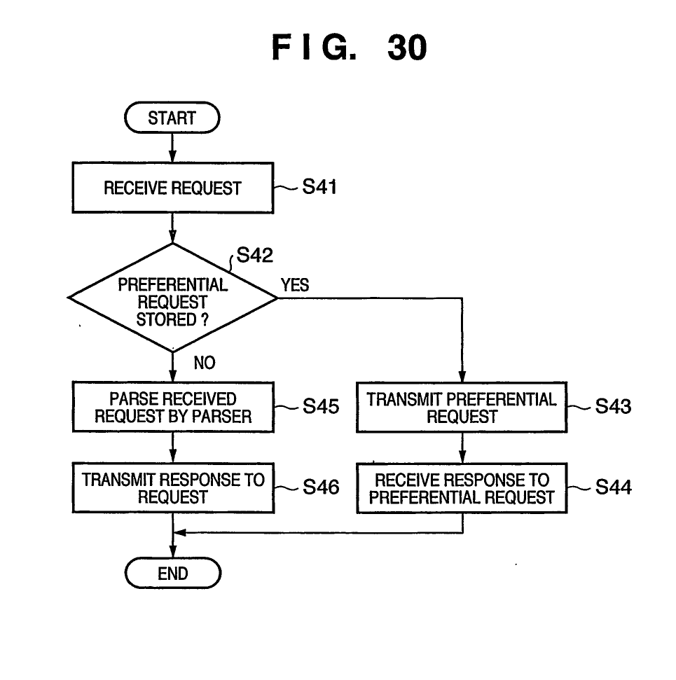

FIG. 30 is a flowchart for explaining the process of the DSC 3012 according to the third embodiment of the present invention. A program that implements the process is stored in the ROM 3101. In this process, it is determined whether a request to be preferentially transmitted is generated, and such request is processed if any.

Upon reception of a request from the PD printer 1000 in step S41, the flow advances to step S42 to determine whether a request which is about to be transmitted to the PD printer 1000 is stored. If the request to be transmitted is stored, the process or the like uses the memory, and a sufficient memory area required to return a response to the request received in step S41 is unlikely to be assured. On the other hand, if no request to be transmitted to the PD printer 1000 is stored, the received request can be interpreted and an appropriate response can be returned. Hence, if the request to be transmitted to the PD printer 1000 is stored, the flow advances to step S43 to discard the request received in step S41, and the request to be transmitted to the PD printer 1000 is transmitted to the PD printer 1000. The flow advances to step S44 to receive a response to the request transmitted in step S43 from the PD printer 1000. In this case, the PD printer 1000 recognizes that the collision has occurred, and also that the initially transmitted request has been discarded by the DSC 3012.

As a result, the DSC 3012 can preferentially process a request of the self device, and can consequently make a free area in the memory. Hence, the DSC 3012 can prepare for the request re-received from the PD printer 1000.

On the other hand, if no request to be transmitted to the PD printer 1000 is stored, the flow advances to step S45. In step S45, the received request is interpreted to generate an appropriate response to the request. In step S46, the generated response is transmitted to the PD printer 1000.

In this manner, a print instruction can be issued to the PD printer 1000 by prioritizing a request from the DSC 3012.

In the above described embodiments, a case where an appropriate response is not returned in response to a request base on a statue of a memory is explained, but the present invention is not limited to the case. For example, there may be adopted to cases in which the electric power capacity of an apparatus for issuing the response is degraded, or the processing ability of CPU of the apparatus is degraded, or the apparatus is in a busy state due to be controlled by another apparatus. In those cases, the apparatus for issuing the response can respond by an appropriate response, but in a case where the ability of the apparatus is degraded, the apparatus may dare to respond by incorrect response in place of the appropriate response.

### Another Embodiment

This embodiment begins with a request of function information of the printer from the DSC 3012 as the image supply device, and exchanges each other's function information. Alternatively, this embodiment can also be achieved by beginning with a request of function information of the DSC 3012 as the image supply device from the printer 1000 as the image printing device, and by exchanging each other's function information.

The objects of the present invention can also be achieved by supplying a storage medium, which records a program code of a software program to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention. As the storage medium for supplying the program code, for example, a floppy® disk, hard disk, optical disk, magneto-optical disk, CD-ROM, CD-R, magnetic tape, nonvolatile memory card, ROM, and the like may be used.

The functions of the above-mentioned embodiments may be implemented not only by executing the readout program code by the computer but also by some or all of actual processing operations executed by an OS (operating system) running on the computer on the basis of an instruction of the program code.

Furthermore, the functions of the above-mentioned embodiments may be implemented by some or all of actual processing operations executed by a CPU or the like arranged in a function extension board or a function extension unit, which is inserted in or connected to the computer, after the program code read out from the storage medium is written in a memory of the extension board or unit.

The present invention is not limited to the above embodiments and various changes and modifications can be made within the spirit and scope of the present invention. Therefore, to apprise the public of the scope of the present invention, the following claims are made.

### CLAIM OF PRIORITY

This application claims priority from Japanese Patent Application No. 2003-298796 filed on Aug. 22, 2003, which is hereby incorporated by reference herein.

1-17. (canceled)

18. A recording system in which an image supply apparatus and a recording apparatus communicate with each other via a general-purpose interface, and the image supply apparatus transmits image data to the recording apparatus using a predetermined protocol to record the image data,
wherein after a communication procedure is established by applications which are installed in the image supply apparatus and the recording apparatus and use the predetermined protocol, in a case where a sender being either the recording apparatus or the image supply apparatus transmits a first request to another apparatus and then receives a second request other than a response to the first request prior to receiving the response from the other apparatus, the sender comprises means for invalidating the second request received from the other apparatus, and
wherein the other apparatus has transmission means for transmitting the second request based on status of the other apparatus.

19. The system according to claim 18, wherein the other apparatus further comprises:
determination means for determining whether or not the information is to be transmitted, in accordance with an operation state of the other apparatus.

20. The system according to claim 18, wherein the second request does not include any operation instruction of the sender.

21. A recording apparatus for communicating with an image supply apparatus and recording an image based on image data received from the image supply apparatus using a predetermined protocol, comprising:
means for invalidating a first request, in a case where the first request other than a response to a second request transmitted to the image supply apparatus is received from the image supply apparatus in response to the second request, after a communication procedure is established by applications which are installed in the recording apparatus and the image supply apparatus; and
transmission means for transmitting a third request other than a response to a fourth request received from the image supply apparatus in accordance with status of the recording apparatus.

22. The apparatus according to claim 21, further comprising determination means for determining whether or not the third request is to be transmitted, in accordance with an operation state of the recording apparatus.

23. The apparatus according to claim 21, wherein the third request does not include any operation instruction of the image supply apparatus.

24. The apparatus according to claim 21, further comprising re-transmission means for re-transmitting the first request to the image supply apparatus, in a case where the second request other than the response to the first request is received from the image supply apparatus.

25. An image supply apparatus for communicating with a recording apparatus and transmitting image data to the recording apparatus using a predetermined protocol, comprising:
means for invalidating a first request, in a case where the first request other than a response to a second request transmitted to the recording apparatus is received from the recording apparatus in response to the second request, after a communication procedure is established by applications which are installed in the recording apparatus and the image supply apparatus; and
transmission means for transmitting a third request other than a response to a fourth request received from the recording apparatus in accordance with status of the image supply apparatus.

26. The apparatus according to claim 25, further comprising determination means for determining whether or not the third request is to be transmitted, in accordance with an operation state of the image supply apparatus.

27. The apparatus according to claim 25, wherein the third request does not include any operation instruction of the recording apparatus.

28. The apparatus according to claim 25, further comprising re-transmission means for re-transmitting the second request to the recording apparatus, in a case where the first request other than the response to the second request is received from the recording apparatus.

29. A communication control method in a recording system in which an image supply apparatus and a recording apparatus communicate with each other via a general-purpose interface, and the image supply apparatus transmits image data to the recording apparatus using a predetermined protocol to record an image, the method comprising:
a step of allowing, in a case where a sender being either the recording apparatus or the image supply apparatus transmits a first request to another apparatus and then receives a second request other than a response to the first request prior to receiving the response from the other apparatus,
wherein the other apparatus has transmission means for transmitting the second request based on status of the other apparatus.

30. The method according to claim 29, further comprising a step of allowing the other apparatus to determine whether or not the second request is to be transmitted, in accordance with an operation state of the other apparatus.

31. The method according to claim 29, wherein the second request does not include any operation instruction of the recording apparatus or the image supply apparatus.

32. A communication control method in a recording apparatus for communicating with an image supply apparatus and recording an image based on image data received from the image supply apparatus using a predetermined protocol, the method comprising:
a step of invalidating a second request, in a case where the second request other than a response to a first request transmitted to the image supply apparatus is received from the image supply apparatus in response to the first request; and
a transmission step of transmitting a third request other than a response to a fourth request received from the image supply apparatus in accordance with status of the recording apparatus.

33. The method according to claim 32, further comprising a re-transmission step of re-transmitting the first request to the image supply apparatus, in a case where the second request other than the response to the first request is received from the image supply apparatus.

34. A communication control method in an image supply apparatus for communicating with a recording apparatus and transmitting image data to the recording apparatus using a predetermined protocol, the method comprising:
a step of invalidating a second request, in a case where the second request other than a response to a first request transmitted to the recording apparatus is received from the recording apparatus in response to the first request; and
a transmission step of transmitting a third request other than a response to a fourth request received from the recording apparatus in accordance with status of the image supply apparatus.

35. A recording apparatus for communicating with an image supply apparatus using a request and a response in a predetermined protocol, comprising:
means for receiving a first request from the image supply apparatus;
first transmission means for transmitting a first response corresponding to the first request to the image supply apparatus, in response to the first request; and
second transmission means for transmitting a second request instead of the first response to the image supply apparatus in accordance with status of the recording apparatus, in response to the first request.

36. An image supply apparatus for communicating with a recording apparatus using a request and a response in a predetermined protocol, comprising:
means for receiving a first request from the recording apparatus;
first transmission means for transmitting a first response to the recording apparatus, in response to the first request; and
second transmission means for transmitting a second request instead of the first response to the recording apparatus in accordance with status of the image supply apparatus, in response to the first request.

37. A control method of a recording apparatus for communicating with an image supply apparatus using a request and a response in a predetermined protocol, comprising the steps of:
receiving a first request from the image supply apparatus;
transmitting a first response corresponding to the first request to the image supply apparatus, in response to the first request; and
transmitting a second request instead of the first response to the image supply apparatus in accordance with status of the recording apparatus, in response to the first request from the image supply apparatus.

38. A control method of an image supply apparatus for communicating with a recording apparatus using a request and a response in a predetermined protocol, comprising the steps of:
receiving a first request from the recording apparatus;
transmitting a first response to the recording apparatus in response to the first request; and
transmitting a second request instead of the first response to the recording apparatus in accordance with status of the image supply apparatus, in response to the first request from the recording apparatus.
